(19) United States
(12) Patent Application Publication
(10) Pub. No.: US 2015/0318611 A1
(43) Pub. Date: Nov. 5, 2015

(54) ANTENNA ARRAY FOR COMMUNICATION SYSTEM

(71) Applicant: ParkerVision, Inc., Jacksonville, FL (US)

(72) Inventors: Gregory S. RAWLINS, Heathrow, FL (US); David F. SORRELLS, Middleburg, FL (US)

(73) Assignee: ParkerVision, Inc., Jacksonville, FL (US)

(21) Appl. No.: 14/703,540

(22) Filed: May 4, 2015

Related U.S. Application Data
(60) Provisional application No. 61/987,828, filed on May 2, 2014.

(51) Int. Cl. H01Q 3/26

(52) U.S. Cl. CPC H01Q 3/26

(57) ABSTRACT

The present disclosure relates to antenna arrays for communication systems. An apparatus comprises an array of antenna elements and a controller configured to independently control modulated or unmodulated phase and modulated or unmodulated gain for two or more signals received or transmitted by the array of antenna elements using energy sampling techniques.

### CROSS REFERENCE TO RELATED APPLICATION

This application claims the benefit of U.S. Provisional Patent Application No. 61/987,828 (Atty. Docket No. 1744.2400000), filed May 2, 2014, titled “Antenna Array Steering and Diversity Processing,” which is incorporated herein by reference in its entirety.

### BACKGROUND

1. Field of the Invention

Embodiments of the present invention are related to antenna arrays for communication systems. Specifically, embodiments of the present invention are directed to independently controlling modulated or unmodulated phase and modulated or unmodulated gain for two or more signals received or transmitted by an array of antenna elements using energy sampling techniques.

2. Background

Antenna arrays for communications can be categorized as transmit antenna arrays and receive antenna arrays. FIG. 1 is an illustration of a conventional transmit antenna array 100. Conventional transmit antenna array 100 routes pre-modulated and amplified carrier signals (e.g., RF carrier 108) with separate delay functions per antenna element 114₀-114ₙ (where “n” is any suitable number) in the array. The amplification and distribution and delay operations at radio frequencies (RF) are large, power consuming, and inefficient. These operations present a formidable RF signal routing challenge.

Another challenge with conventional transmit antenna arrays (e.g., transmit antenna array 100 of FIG. 1) relates to amplification at a central point after modulation and prior to modulated RF signal distribution to each antenna element via RF power dividers. The RF power divider attenuates the pre-amplified and pre-modulated signal considerably as the number of antenna elements increases. Losses are on the order of [10 log₁₀ (n)+(routing loss in dB)], where n is the number of antenna elements. This loss should be considered in the gain design for the antenna array.

Conventional receive antenna arrays also suffer from drawbacks. FIG. 2 is an illustration of a conventional receive antenna array 200. Receive antenna array 200 distributes RF signals from each array element 202₀-202ₙ (where “n” is any number) through a distribution manifold with weighted phase shifting or delay (e.g., via phase shifters 206₀-206ₙ) (where “n” is any suitable number) and gain functions (e.g., gain control circuits 208₀-208ₙ) (where “n” is any suitable number) in each RF path. The separately processed paths are then recombined prior to demodulation (e.g., in RF combiner 210). Traditional techniques recombine the separately processed paths prior to demodulation. The distribution manifold and phase shift network introduce inefficiencies.

### SUMMARY

A need exists to address drawbacks in conventional transmit and receive antenna array designs.

In an embodiment, an apparatus comprises an array of antenna elements and a controller configured to independently control modulated or unmodulated phase and modulated or unmodulated gain for two or more signals received or transmitted by the array of antenna elements using energy sampling techniques.

Further features and advantages of the embodiments disclosed herein, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to a person skilled in the relevant art based on the teachings contained herein.

### BRIEF DESCRIPTION OF THE FIGURES

The accompanying drawings, which are incorporated herein and form a part of the specification, illustrate embodiments of the present invention and, together with the description, further serve to explain the embodiments and to enable a person skilled in the relevant art to make and use the invention.

FIG. 1 is an illustration of a conventional transmit antenna array.

FIG. 2 is an illustration of a conventional receive antenna array.

FIG. 3 is an illustration of an embodiment of a sampled D2p™ transmit antenna array architecture.

FIG. 4 is an illustration of an embodiment of a sampled D2d™ receive antenna array architecture.

FIG. 5 is an illustration of an embodiment of a direct sample clock phase shifter.

FIG. 6 is an illustration of an example complex phasor representing phase rotated sample clock, in accordance with one or more embodiments.

FIG. 7 is an illustration of an embodiment of a D2pAP™ module.

FIG. 8 is an illustration of an embodiment of a D2d™ AP module.

FIG. 9 is an illustration of an example complex signal plane decomposition of in-phase and quadrature phase signals, in accordance with one or more embodiments.

FIG. 10 is an illustration of an example rotated complex vector signal, in accordance with one or more embodiments.

FIG. 11 is an illustration of an embodiment of a D2d™ complex down converter.

FIG. 12 is an illustration of an embodiment of a D2p™ complex up converter.

FIG. 13 is an illustration of an embodiment of a D2d™ complex up converter.

FIG. 14 illustrates an embodiment of a D2d™ complex down converter.

FIG. 15 illustrates an embodiment of a 25% duty cycle D2d™ complex down converter.

FIG. 16 illustrates an embodiment of a D2d™ complex up converter.

FIG. 17 illustrates an embodiment of a 25% duty cycle D2d™ complex up converter.

Embodiments will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### Introduction

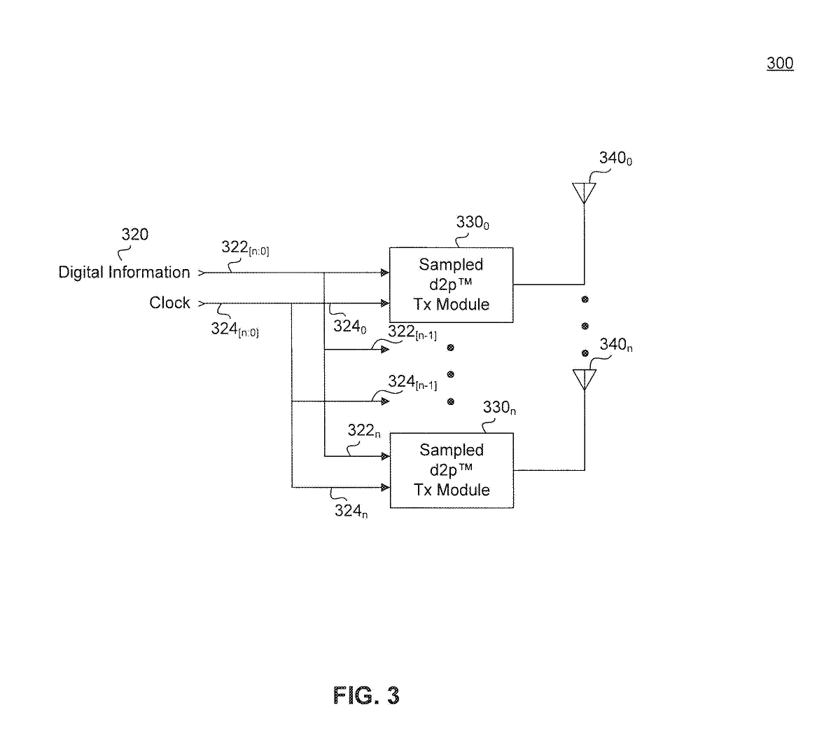

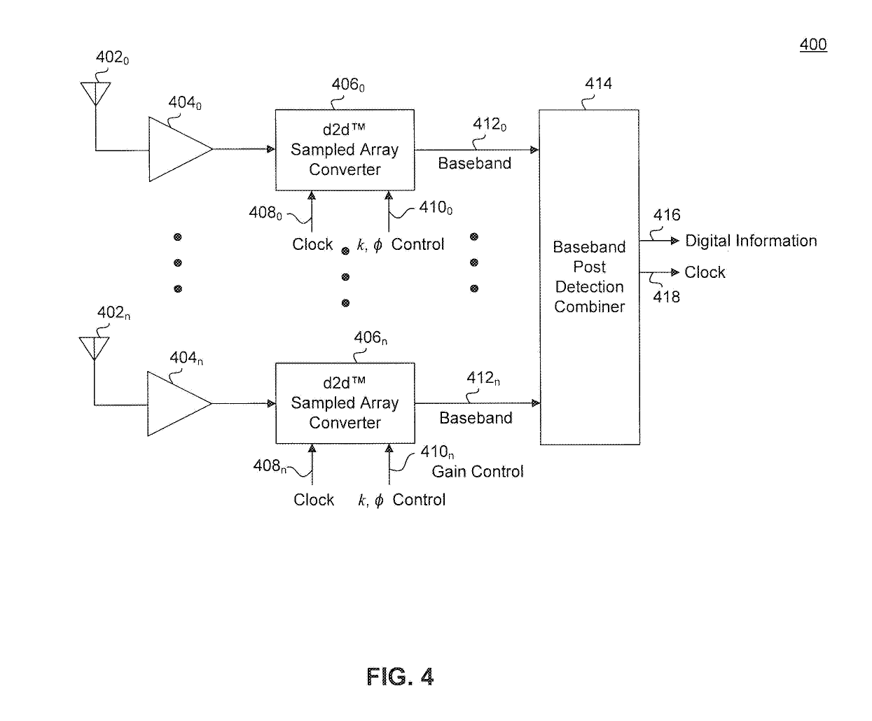

Embodiments herein disclose an agile multi-element electronic antenna steering method and technology. The antenna steering method and technology controls a composite beam of two or more antenna elements. The technology can be based on various sampling techniques such as, for example, D2p™ and D2d™ sampling techniques. D2p generally refers to creating highly linear RF power waveforms for receiver and transmitter technology. D2d generally refers to direct conversion receiver and transmitter technology that enables robust signal reception in environments that contain jamming signals. This is achieved by transmitting multiple redundant information frequency spectrums. The spectrums are spaced close together, thereby reducing communication bandwidth requirements. Both transmit and receive antenna beams are controlled, resulting in signals that are transmitted or received with the greatest efficiency. Transmission or reception includes complex modulation or demodulation operations. FIG. 3 is an illustration of an embodiment of a sampled D2p™ transmit antenna array architecture 300. FIG. 4 is an illustration of an embodiment of a sampled D2d™ receive antenna array architecture 400. FIGS. 3 and 4 are described in further detail below.

In an embodiment, using D2p™ and D2d™ energy sampling technologies, phase shifting of a modulated radio frequency (RF) carrier signal can be accomplished at each element of an antenna array. Hence, information can be routed in digital, analog or hybrid forms up to the point of carrier modulation and carrier phase shifting at each array element. Moreover, due to efficiencies in D2p™ and D2d™ energy sampling technologies, these technologies can be highly integrated, thus providing the greatest flexibility in signal routing, array packaging and heat removal. Embodiments disclosed herein are directed to a method that amalgamates and coordinates properly phased RF power modulation from a digital interface and clock at each array element of an antenna array or cluster of array elements.

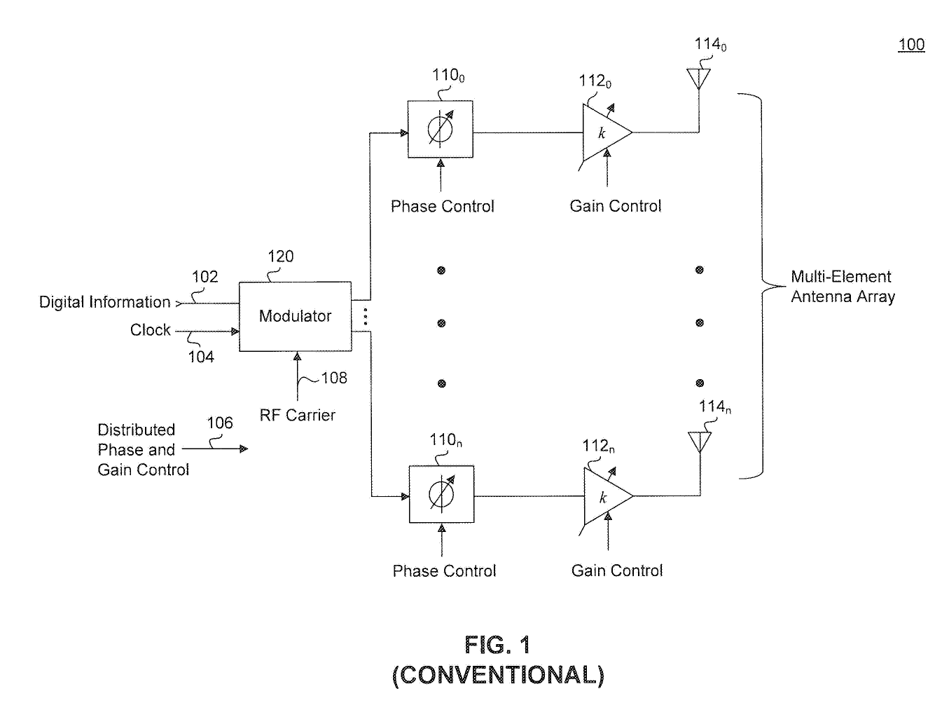

Referring back to FIG. 1, information 102 is transferred to the modulator 120 with a synchronous clock 104. Asynchronous data or an analog signal interface can also be used in lieu of the illustrated input. An RF local oscillator 108 is used by a complex up converter within the modulator/PA (power amplifier)/RF power divider module/modules 120 to modulate the input data onto in phase (I) and quadrature phase (Q) components of the RF carrier. Multiple (up to n where n is an integer greater than 1) distribution branches out of the Modulator/PA 120 are formed by splitting the modulated RF carrier via an RF power divider (not illustrated separately and absorbed into the Modulator/PA module). Each output branch signal is phase shifted via phase shift elements 110₀-110ₙ, (where “n” is any suitable number) phase shift controls, and distributed phase and gain control 106. Each output branch signal is scaled via gain control elements 110₀-110ₙ, (where “n” is any suitable number) gain controls, and distributed phase and gain control 106. Each phase shifted and scaled branch signal is then routed to antenna elements 114₀-114ₙ. (where “n” is any suitable number) The number of branches and antenna elements is greater than or equal to 2. By suitable selection of the phase and gain of the branch signals, the desired elevation and azimuth of the antenna beam can be pointed or steered to a desired direction for maximum gain, minimum gain or some suitable other gain depending on the application. This process can be agile or “on the fly” (e.g., process parameters are modified at or during the time of operation), for example, dynamically varied, user controlled, or changed in “real-time,” or changed based on settings other than initial settings that are established at the time of fabrication. Additionally, “on the fly” can also include changes that a user selects at a user-defined time, and then utilizes these changes to modify the process. It is understood that the foregoing discussion can be applied to the case of diversity transmission or multiple output transmission. If the information modulated onto the branches is desired to be different between the branches then the modulator/PA module 120 can utilize redundancy of function internally and unique RF power divider distribution for each uniquely modulated signal but the process is essentially the same as the foregoing discussion otherwise. The PA function can occur prior to the RF power dividing and branch distribution function. However, it is also possible to provide separate PA functions along with elements 112₀-112ₙ (where “n” is any suitable number) for each branch.

With regard to the conventional transmit antenna array of FIG. 1 (discussed above), embodiments disclosed herein remove losses associated with the RF power divider and the addition of antenna elements, greatly enhancing efficiency and linearity. In addition, production of the RF carrier power at the point of transmit (i.e., at the antenna or near to it) distributes unwanted heat for removal and lowers the power supply overhead required to achieve an overall output RF transmit power.

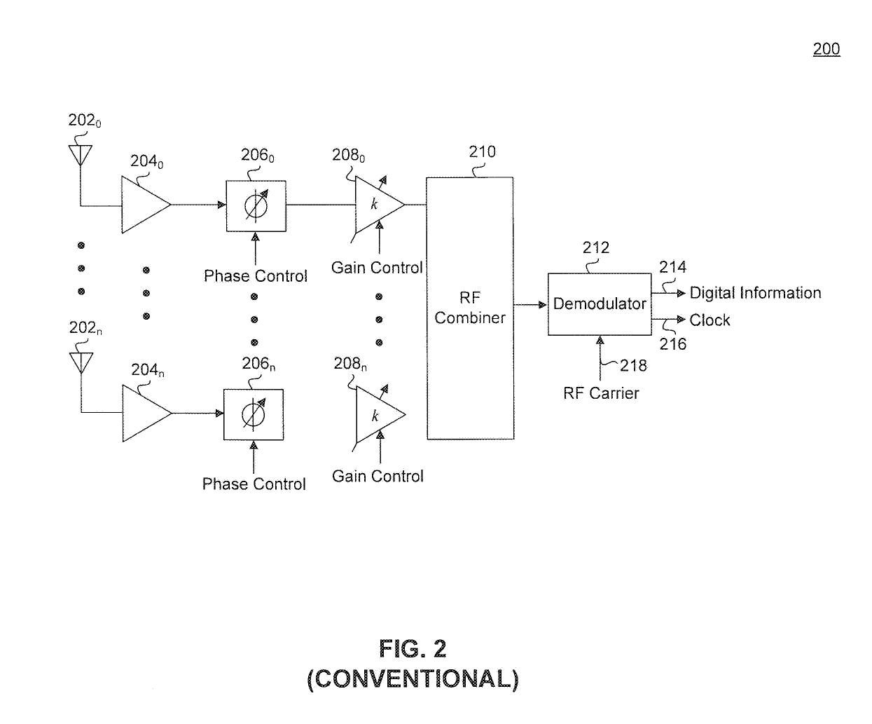

Referring back to FIG. 2, multiple antenna elements 202₀-202ₙ (where “n” is any suitable number) receive multiple RF signals in parallel. Each received branch signal is amplified by low noise amplifiers (LNA)s 204₀-204ₙ. (where “n” is any suitable number) Each amplified branch signal is then phase shifted via phase shift elements 206₀-206ₙ (where “n” is any suitable number) and phase controls. Each branch signal is scaled via gain scaling elements 208₀-208ₙ (where “n” is any suitable number) and gain controls. The phase shifted and gain scaled branches are combined in an RF signal combiner 310 and demodulated in demodulator module 212. In this example, the down converted signal is digitized and output for distribution as digital information 214. The data in this example is accompanied by an output clock 216. It is understood that the output format can be parallel, serial, synchronous, or asynchronous. An RF carrier LO waveform reference 218 is supplied to the demodulator to assist in the down conversion process. The down conversion architecture can be zero IF (ZIF), suitable low IF, or super heterodyne and can comprise in phase (I) and quadrature (Q) phase baseband or low IF components or other suitable format. Although this example illustrates a digital output, it is to be understood that the signal distribution can comprise the analog down converted signal prior to digitization. When unique information (i.e., a uniquely modulated receive signal is to be received at some number of antenna elements) is received on some number of branches, the architecture of FIG. 2 will generally be redundant at the demodulator 212 and RF power combiner 210, as well as during output data distribution. Signal flow can be parted in a manner such that the demodulated data can be distributed which preserves the integrity of the received information. The foregoing discussion can apply to arrays of antenna elements, diversity antenna structures, and MIMO applications, depending on the nature of the received RF signals and application.

With regard to the conventional receive antenna array of FIG. 2 (discussed above), embodiments disclosed herein improve on the traditional technique of distributing RF signals from each antenna array element through the distribution manifold with weighted phase shifting or delay and gain functions in each RF path. The traditional technique recombines the separately processed paths prior to demodulation. The distribution manifold and phase shift network introduce inefficiencies. As described in relation to embodiments of this invention, such as, using D2d™ sampling techniques, these inefficient elements can be removed or the inefficient effects from the elements can be reduced. Each element or local cluster of elements can possess its own beam steering and demodulation capability. This removes the limitations associated with separate gain and phase shifting functions, such as unwanted losses, linearity concerns, and control signal routing. The individual D2p™ sampled array down converter outputs are recombined at or near baseband (BB) rather than RF, according to an embodiment, though any suitable aliased IF of the sampled down conversion can be chosen. The BB signals can be digital or analog.

Advantages of the embodiments include, among other things, bulky phase shift components in the conventional transmit and receive antenna arrays can be replaced with fully integrated circuits, thereby reducing cost and size. In some embodiments, receive and transmit antenna elements can be the same physical structure or a mechanically shared realization.

The architectures and technologies in the sampled D2p™ and D2d™ antenna array architectures of FIGS. 3 and 4, respectively, are also suited for general multi-antenna element applications as well as traditional phased array applications. Thus, the architecture can be dynamically optimized for a particular application. For example, the sampled D2p™ and D2d™ antenna array architectures can be employed in multiple input multiple output (MIMO) system applications or diversity processing applications, such as those where the diversity implementation can be polarization, space, or wavelength in nature. Therefore, it is possible to process the same modulated information per antenna element, unique information per antenna element or a mixture of information channels. This process can increase overall channel capacity while delivering the benefits of lower cost, smaller size, lower heat production and flexible signal routing options when D2p™ and D2d™ processing technologies are used.

Processors associated with the sampled D2p™ and D2d™ antenna array architectures can be used to process any standards-based (such as relevant IEEE standards, organized-body-setting standards, and other uniform, or agreed-upon performance criteria for similar devices and/or functionality) or custom waveform without changing components, amplifiers, networks, etc. Conventional processing techniques do not share this benefit. This is not practical using conventional processing techniques.

In some cases, the conventional antenna architectures shown in FIGS. 1 and 2 can be altered such that multiple antenna elements (a cluster) share part or all of a particular sampled D2p™ and D2d™ array converter module, RF power dividers or combiners, etc. This further enhances efficiency, size, cost and packaging advantages over conventional technology approaches.

In addition the sampled D2p™ and D2d™ array processors can be operated in simplex, half duplex, full duplex, or multiplex architectures.

### DEFINITIONS

As used herein, the term Adjacent-Channel Power Ratio (ACPR) refers to a ratio of power in some adjacent band compared to the desired signal power in a band of interest. ACPR is usually measured in decibels (dB) as the ratio of an out of band power per unit bandwidth to an in band signal power per unit bandwidth. This measurement is usually accomplished in the frequency domain. Out of band power is typically unwanted.

As used herein, the term antenna array refers to an assembly of antenna elements with the proper dimensions, characteristics, and spacing, so as to maximize the intensity of radiation in desired directions.

As used herein, the term annihilation of information refers to transfer of information entropy into non-information bearing degrees of freedom no longer accessible to the information bearing degrees of freedom of the system and therefore lost in a practical sense even if an imprint is transferred to the environment through a corresponding increase in thermodynamic entropy.

As used herein, the term antenna gain refers to the effectiveness or alternatively the power transmission gain, generally expressed in decibels, of a directional antenna as relative to a given standard, such as a dipole or isotropic antenna.

As used herein, the term amplification refers to power amplification unless otherwise indicated.

As used herein, the terms aperture and sampling aperture refer to the time interval during which a sample of a signal is acquired or generated/created. An aperture can be characterized by a voltage, current, or energy (i.e. functions of time and pulses) value over the time interval. The aperture can be rectangular (time axis on the horizontal) or any other suitable shape. For example, the aperture can have a peak value for the voltage, current, or energy with a rise time and a fall time for the pulse shape associated with the function of time. The pulse shape over the aperture can be continuous, piece-wise continuous, or some hybrid of these two types of functions over the interval, including the interval boundaries. For the purposes herein, aperture times and pulse features can be variable quantities to enable various features of the invention.

As used herein, the term auto-correlation refers to a method of comparing a signal with itself. For example, Time—Auto Correlation compares a time shifted version of a signal with itself.

As used herein, the term bandwidth refers to a frequency span over which a substantial portion of a signal is restricted according to some desired performance metric. Often, a 3 dB metric is allocated for the upper and lower band (span) edge to facilitate the definition. However, sometimes a differing frequency span is allocated. Span can also be referred to as band or bandwidth depending on context.

As used herein, the term blended control function refers to a set of dynamic and configurable controls which are distributed to an apparatus according to an optimization algorithm which accounts for H(x), the input information entropy, the waveform standard, all significant hardware variables and operational parameters. Optimization provides a trade-off between thermodynamic efficiency and waveform quality. BLENDED CONTROL BY PARKERVISION™ is a registered trademark of ParkerVision, Inc., Jacksonville, Fla.

As used herein, the term bin refers to a subset of values or span of values within some range or domain.

As used herein, the term bit refers to a unit of information measure calculated using numbers with a base of 2.

As used herein, the term Boltzmann's Constant refers to k_{B}≅1.38×10^{-2 3} Joules/Kelvin(J/K).

As used herein, the abbreviation C is an abbreviation for coulomb, which is a quantity of charge.

As used herein, the term capacity refers to the maximum possible rate for information transfer through a communications channel, while maintaining a specified quality metric. Capacity can also be designated (abbreviated) as C, or C with possibly a subscript, depending on context. It should not be confused with Coulomb, a quantity of charge.

As used herein, the term carrier signal refers to a signal which can be modulated in frequency, amplitude, or phase, for it to carry information. For instance, an AM radio transmitter modulates the amplitude of a carrier signal. An RF carrier signal is a carrier with a fundamental radio frequency which can be clearly specified in terms of some nominal frequency and amplitude prior to application of modulation.

As used herein, the term cascading refers to transferring a quantity or multiple quantities sequentially.

As used herein, the term cascading refers to using a power source connection configuration to increase potential energy.

As used herein, the term charge refers to the fundamental unit in coulombs associated with an electron or proton, ˜±1.602×10⁻¹⁹ C., or an integral multiplicity thereof.

As used herein, the term cluster refers to a fixed number of antenna elements accessed as a unit for the purpose of transmit or receive RF signal processing.

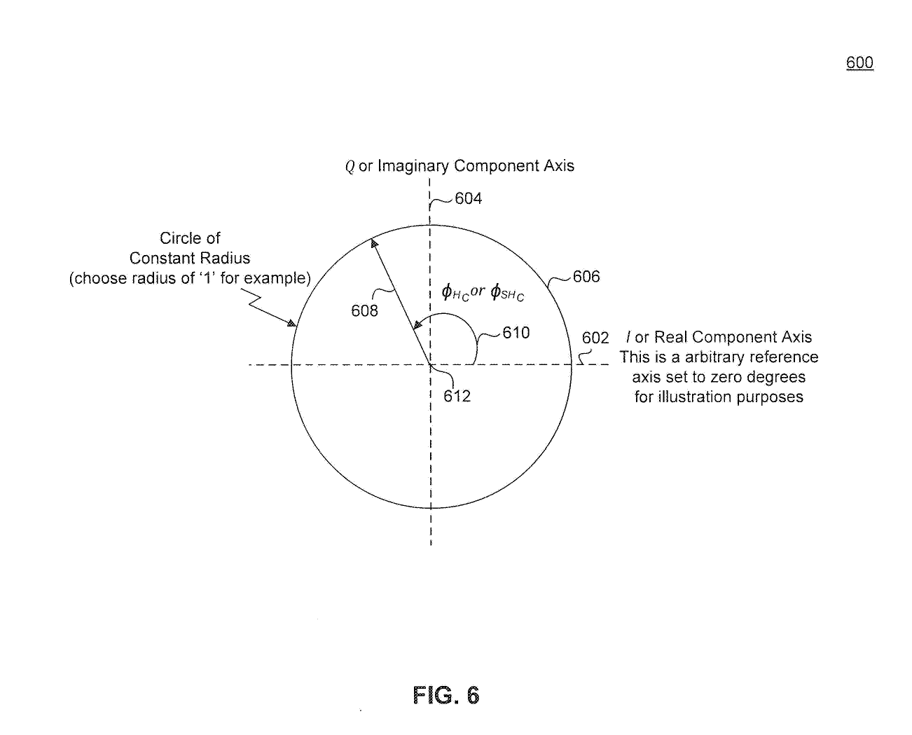

As used herein, the term complex phasor refers to a complex signal vector with a vector origin at the complex plane origin, which possesses a phase angle in the complex plane, which can be a dynamic function. An example dynamic phasor function is rotating the complex signal vector as a function of time within the complex plane. An example is show as element 608 in FIG. 6.

As used herein, the term code refers to a combination of symbols which collectively can possess an information entropy.

As used herein, the term communication refers to transfer of information through space and time.

As used herein, the term communications channel refers to any path that transports a signal whether material or spatial in nature

As used herein, the term communications sink refers to a targeted load for a communications signal or an apparatus that utilizes a communication signal.

As used herein, the term complex plane refers to a plane with two perpendicular axes upon which complex numbers are represented. The horizontal axis represents the real number component (also called in phase (I) component where applicable for this disclosure), while the vertical axis represents the imaginary number component (also called quadrature phase (Q) component where applicable for this disclosure).

As used herein, the term complex signal envelope refers to a mathematical description of a signal suitable for RF application, such as the following:

$$x ( t ) = a ( t ) {e}^{j ( {ω}_{c} t + φ ( t ) )}$$

$$x ( t ) = {a}_{I} ( t ) cos ( {ω}_{c} t + φ ( t ) ) - {a}_{Q} ( t ) sin ( {ω}_{c} t + φ ( t ) )$$

$${ω}_{c} ≡ Carrier Frequency$$

$$φ ( t ) ≡ Phase Information vs . Time$$

$$a ( t ) ≡ Amplitude Information vs . Time$$

$$\vert a ( t ) \vert = \sqrt{{a}_{I}^{2} ( t ) + {a}_{Q}^{2} ( t )}$$

$$φ ( t ) = arc tan [ \frac{{a}_{Q} ( t )}{{a}_{I} ( t )} ]$$

As used herein, the terms composite beam, antenna beamwidth, and beam width refer to an angle between the points at which the intensity of an antenna is at half (or some other specified quantity) of its maximum value. A composite beam can be measured in the horizontal plane and/or the vertical plane. The composite beam or beamwidth can be a variable quantity depending on the gain and phase of the RF carrier at each antenna element and/or the physical construction of the antenna array. The composite beam or beamwidth can be steered or pointed in a direction relative to some reference direction, such as zero degrees azimuth and zero degrees elevation, for example. The pointing or steering can be dynamic and variable according to the gain and phase of the RF carrier at each antenna element whenever more than one antenna element is being controlled.

As used herein, the term compositing refers to the mapping of one or more constituent signals or portions of one or more constituent signals to domains and their subordinate functions and arguments according to a dynamic co-variance or cross correlation of said functions. Blended Controls weight the distribution of information to each constituent signal. The composite statistic of the blended controls is determined by an information source with source entropy of H(x), the number of the available degrees of freedom for the apparatus, the efficiency of each degree of freedom, and the corresponding potential to distribute a specific signal rate in each degree of freedom.

As used herein, the term constellation refers to the set of signal coordinates in the complex plane with values determined from a_{I}(t) and a_{Q}(t) and plotted graphically with a_{I}(t) versus a_{Q}(t) or vice versa.

As used herein, the term correlation refers to the measure by which the similarity of two or more variables can be compared. A measure of 1 implies they are equivalent and a measure of 0 implies the variables are completely dissimilar. A measure of (−1) implies the variables are opposite. Values between (−1) and (+1) other than zero also provide a relative similarity metric.

As used herein, the term complex correlation refers to correlation in which the variables which are compared are represented by complex numbers. The resulting metric can have a complex number result.

As used herein, the term covariance refers to a correlation operation for which the random variables of the arguments have their expected values extracted prior to performing correlation.

As used herein, the term cumulative distribution function (CDF or cdf) refers to the function in probability theory and statistics that describes the probability that a real-valued random variable X with a given probability distribution will be found at a value less than or equal to x. Cumulative distribution functions are also used to specify the distribution of multivariate random variables. A CDF can be obtained through an integration or accumulation over a relevant probability density (pdf) domain.

As used herein, the term data stream refers to the continuous flow of data over a communications channel.

As used herein, the term decoding refers to the process of extracting information from an encoded signal.

As used herein, the term decoding time refers to the time interval to accomplish decoding.

As used herein, the term degrees of freedom refers to the dimension, or dimensions, or subset of a dimension(s), of some space into which energy and/or information can individually or jointly be imparted and extracted. Such a space can be multi-dimensional and sponsor multiple degrees of freedom. A single dimension can also support multiple degrees of freedom.

As used herein, the term density of states for phase space refers to a set of relevant coordinates of some mathematical, geometrical space which can be assigned a unique time and/or probability, and/or probability density. The probability densities can statistically characterize meaningful physical quantities that can be further represented by scalars, vectors and tensors.

As used herein, the term desired degree of freedom refers to a degree of freedom that is efficiently encoded with information. These degrees of freedom are information conservative and energetically conservative. They are also known as information bearing degrees of freedom. These degrees of freedom can be deliberately controlled or manipulated to affect the causal response of a system through and application, algorithm or function.

As used herein, the abbreviation DCPS refers to a digitally controlled power or energy source.

As used herein, the term dimension refers to a metric of a mathematical space. A single space can have one or more than one dimension. Often, dimensions are orthogonal. Ordinary space has 3-dimensions: length, width and depth. However dimensions can include time metrics, frequency metrics, phase metrics, space metrics and abstract metrics as well, in any quantity or combination.

As used herein, the term direct to power (D2p™) refers to a direct to power modulator device.

As used herein, the term direct to data array processor (D2d™AP) refers to a D2d™ based processor suitable for controlling the gain and phase of a received or transmitted modulated carrier for the purpose of steering the beam of a plurality of antenna elements or for the purpose of direct RF down conversion or direct RF up conversion. The baseband interface can be in I and Q format for the information to be received or transmitted.

As used herein, the term direct to power array processor (D2p™AP) refers to a D2p™ based processor used for controlling the gain and phase of a transmitted modulated carrier for the purpose of steering the beam of a plurality of antenna elements or for the purpose of direct RF up conversion. The up converted data can be in I and Q format at the baseband transmit interface.

As used herein, the term distribution manifold refers to a structure or structures used to distribute received and/or transmit modulated RF carrier signals for the purpose of receive signal processing or transmit signal processing.

As used herein, the term domain refers to a range of values or functions of values relevant to mathematical or logical operations or calculations. Domains can apply to multiple dimensions and therefore bound hypergeometric quantities and they can include real and imaginary numbers, or any set of logical and mathematical functions and their arguments.

As used herein, the term down-convert refers to the process of removing the RF carrier from a modulated RF carrier. The process can include direct down conversion zero intermediate frequency (ZIF) at the down converted output or some other suitable lower intermediate frequency depending on application. The information modulated onto the RF carrier is preserved in the down conversion processed and conveyed by the down converter apparatus in a format suitable for subsequent processing.

As used herein, the terms down-converter and downconverter refer to a converter whose output frequency is lower than its input frequency. This contrasts with an up-converter whose output frequency is higher than that of the input. When the down conversion results in a zero frequency carrier output, it is referred to as ZIF. A direct conversion signal can be ZIF or some low relatively offset frequency which can be further resolved using digital signal processing.

As used herein, the term duty cycle refers to a ratio of pulse duration to pulse repetition period, expressed as a percentage or a decimal number depending on context. For example, the effective aperture duration of a pulse time divided by the time between successive pulses for a periodic pulse sequence.

As used herein, the term encoding refers to a process of imprinting information onto a waveform to create an information bearing function of time.

As used herein, the term encoding time refers to the time interval to accomplish encoding.

As used herein, the terms efficiency, output efficiency, and power efficiency refer to ratio of the useful power or energy output of a device or system to its total power or energy input.

As used herein, the term energy refers to the capacity to accomplish work where work is defined as the amount of energy required to move an object (material or virtual) through space and time.

As used herein, the term energy function refers to any function that can be evaluated over its arguments to calculate the capacity to accomplish work, based on the function arguments.

As used herein, the term energy partition refers to a function of a distinguishable gradient field, with the capacity to accomplish work.

As used herein, the terms energy source or energy sources refer to a device which supplies energy from one or more access nodes to one or more apparatus. One or more energy sources can supply a single apparatus. One or more energy sources can supply more than one apparatus.

As used herein, the term entropy refers to an uncertainty metric proportional to the logarithm of the number of possible states in which a system can be found according to the probability weight of each state. For example, information entropy is the uncertainty of an information source based on all the possible symbols from the source and their respective probabilities. As another example, physical entropy is the uncertainty of the states for a physical system with a number of degrees of freedom. Each degree of freedom can have some probability of energetic excitation.

As used herein, the term ergodic refers to stochastic processes for which statistics derived from time samples of process variables correspond to the statistics of independent ensembles selected from the process. For ergodic ensemble, the average of a function of the random variables over the ensemble is equal with probability unity to the average over all possible time translations of a particular member function of the ensemble, except for a subset of representations of measure zero.

As used herein, the term ether refers to an electromagnetic transmission medium, usually ideal free space unless otherwise implied.

As used herein, the term error vector magnitude (EVM) refers to a sampled signal that is described in vector space. The ratio of power in the unwanted variance (or approximated variance) of the signal at the sample time to the root mean squared power expected for a proper signal.

As used herein, the term Flutter™ refers to fluctuation of one or more energy partitions and any number of signal parameters. Includes interactively manipulating components outside of the energy source. FLUTTER™ is a registered trademark of ParkerVision, Inc. Jacksonville, Fla.

As used herein, the symbols ℑ{ } or \tilde{ℑ}{ } are used to indicate a “function of” the quantity or expression (also known as argument) in the bracket { }. The function can be in combination of mathematical and/or logical operation.

As used herein, the terms full-duplex (FDX) and full-duplex communication refer to a two-way communication which occurs simultaneously in both directions for a communications channel. This contrasts with half-duplex, in which communication can only occur in one direction at a time.

As used herein, the terms fundamental, fundamental frequency, fundamental component, and first harmonic refer to the sinusoidal component having the lowest frequency for a complex signal, wave, or vibration that is periodic. All integral multiples are called harmonics, such that the second harmonic is twice the fundamental frequency, the third harmonic is three times the fundamental frequency, and so on. Any even-numbered multiple of the fundamental frequency is called an even harmonic, and any odd-numbered multiple is called an odd harmonic.

As used herein, the term generation can refer to any one or more of the following: (1) the process of producing something, such as energy, a signal, a voltage, a current, a result, a set of instructions, etc. Generating can comprise one or more steps for a procedure; (2) the process of converting any form of energy into any other form of energy; (3) the process of converting another form of energy into electrical energy; (4) the process of producing a phase and/or a gain for a signal and/or waveform; (5) the process of producing an alternating current or voltage of a desired frequency; and (6) the process or procedure for producing a pulse of particular aperture and pulse characteristic.

As used herein, the terms half-duplex (HDX) and half-duplex communication refer to a two-way communication in which communication can only occur one direction at a time for a communications channel. This contrasts with full-duplex, in which communication can occur simultaneously in both directions.

As used herein, the term hyper geometric manifold refers to a mathematical surface described in a space with 4 or more dimensions. Each dimension can also comprise complex quantities.

As used herein, the term I refers to the symbol for an in phase component or real component of a complex signal representation.

As used herein, the term information entropy (usually given the symbol notation H(x)) refers to the entropy of a source alphabet or the uncertainty associated with the occurrence of symbols from a source alphabet. The metric H (x) can have units of bits or even bits/per second depending on context but is defined by

$$H ( x ) {\sum }_{i}^{ } - p ( {x}_{i} ) {log}_{b} ( p ( {x}_{i} ) )$$

in the case where p(x)ᵢ is a discrete random variable. If p(x)ᵢ is a continuous random variable then:

$$H ( x ) = - \int p ( x ) {log}_{b} \frac{p ( x ) d x}{m ( x )}$$

With mixed probability densities, mixed random variables, both discrete and continuous entropy functions can apply with a normalized probability space of measure 1. Whenever b=2 the information is measured in bits. If b=e then the information is given in nats. H(x) can often be used to quantity an information source.

As used herein, the term information bearing function of time refers to any waveform, which has been encoded with information, and therefore becomes a signal.

As used herein, the term information bearing function refers to any set of information samples which can be indexed.

As used herein, the term instantaneous efficiency refers to a time variant efficiency obtained from the ratio of the instantaneous output power divided by the instantaneous input power of an apparatus, accounting for statistical correlations between input and output. The ratio of output to input powers can be averaged.

As used herein, the term local oscillator (LO) refers to local oscillator signal, a local oscillator device, a local oscillator waveform, or a local oscillator source.

As used herein, the term low-noise amplifier (LNA) refers to an amplifier that contributes an especially small amount of noise to the desired signal to be amplified. A LNA can be used, for example, to amplify a weak satellite signal that is reflected by a satellite dish.

As used herein, the term macroscopic degrees of freedom refers to the unique portions of application phase space whose separable probability densities can be manipulated by unique physical controls derivable from the function \tilde{ℑ}{H(x)ᵥ_{ᵢ}}. This function takes into consideration, or accounts for, desired degrees of freedom and undesired degrees of freedom for the system. These degrees of freedom (undesired and desired) can be a function of system variables and can be characterized by a priori information.

As used herein, the term microscopic degrees of freedom refers to spontaneously excited due to undesirable modes within the degrees of freedom. These can include, for example, unwanted Joule heating, microphonics, proton emission and a variety of correlated and uncorrelated signal degradations.

As used herein, the term mixed partition refers to a partition comprising scalars or vectors tensors with real or imaginary number representation in any combination.

As used herein, the term module refers to a processing related entity, either hardware (such as electronic circuits, portions of electronic circuits, electronic components, and combinations of electronic components, including electronic circuit elements and/or portions thereof), software, or a combination of hardware and software, or software in execution. For example, a module can be, but is not limited to being, a process running on a processor, a processor, an object, an executable, a thread of execution, a program, and/or a computer. One or more modules can reside within a process and/or thread of execution and a module can be localized on one chip or processor and/or distributed between two or more chips or processors. The term “module” can include, for example, software code, machine language or assembly language, an electronic medium that can store an algorithm or algorithm or a processing unit that is adapted to execute program code or other stored instructions.

As used herein, the term minimum mean square error refers to minimizing the quantity [symbol] (\tilde{X}−X)² [symbol] where \tilde{X} is the estimate of X, a random variable \tilde{X} is usually an observable from measurement or can be derived from an observable measurement, or implied by the assumption of one or more statistics.

As used herein, the term multiple input multiple output (MIMO) refers to multiple antenna diversity.

As used herein, the term multiple input single output (MISO) refers to an operator that creates or generates an output signal from a composite of input signals. The operation or process/procedure can be some combination of nonlinear and linear functions of the inputs.

As used herein, the term modulated refers to any one or more of the following: (1) to modify a characteristic of a wave or signal proportionally to a characteristic present in another wave or signal. For example, to encode an RF carrier with information on its phase (i.e. phase modulation (PM)), frequency (i.e. frequency modulation (FM)), amplitude (i.e. amplitude modulation (AM)) or some combination of the three modulation types; and (2) to modify a characteristic of a carrier wave by an information-bearing signal, for example, as occurs in AM, FM, or PM.

As used herein, the term nat refers to a unit of information measure calculated using numbers with a natural logarithm base.

As used herein, the term node refers to a point of analysis, calculation, measure, reference, input or output, related to procedure, algorithm, schematic, block diagram or other hierarchical object.

As used herein, the abbreviation PAER refers to peak to average energy ratio, a parameter that can be measured in dB, if desired. PAER can also be defined as the ratio of some relatively extreme statistic of an energy function to its average.

As used herein, the abbreviation PAPR refers to peak to average power ratio, which can be measured in dB, if desired.

As used herein, the term partitions refers to boundaries within phase space that enclose points, lines, areas, and volumes. Partitions can possess physical or abstract description, and relate to physical or abstract quantities. Partitions can overlap one or more other partitions. Partitions can be described using scalars, vectors, tensors, real or imaginary numbers along with boundary constraints.

As used herein, the terms probability distribution and probability distribution function (PDF) refers to a mathematical function relating a value from a probability space to another space characterized by random variables.

As used herein, the term probability density (pdf) refers to the probability that a random variable or joint random variables possess versus their argument values. The pdf can be normalized so that the accumulated values of the probability space possesses a measure of the CDF.

As used herein, the term phase space refers to a conceptual space that can be composed of real physical dimensions as well as abstract mathematical dimensions, and described by the language of probability theory and geometry.

As used herein, the term power function refers to an energy function per unit time or the partial derivative of an energy function with respect to time. If the function is averaged, it is an average power. If the function is not averaged it can be referred to as an instantaneous power. Power function has units of energy per unit time and so each coordinate of a power function has an associated energy which occurs at an associated time. A power function does not change the units of its time distributed resource (i.e. energy).

As used herein, the term power source refers to an energy source which is described by a power function. It can possess a single voltage and/or current or multiple voltages and/or currents deliverable to an apparatus or a load. A power source can also be referred to as power supply.

As used herein, the term pseudo-phase space refers to an alternate representation or approximation of a phase space.

As used herein, the term Q refers to the symbol of a quadrature phase or imaginary component of a complex signal representation.

As used herein, the terms radio frequency (RF), RF frequency, and RF range refer to any one or more of the following: (1) a frequency or interval of frequencies utilized for communications within the electromagnetic spectrum; (2) a specific interval of RF frequencies, such as, for example, those in the radio spectrum; (3) a specific RF, such as that of a carrier wave or HF (high frequency), VHF (very high frequency), UHF (ultra-high frequency), SHF (super-high frequency); (4) a rate of oscillation in the range of about 3 kHz to 300 GHz, which corresponds to the frequency of radio waves, and the alternating currents, which carry radio signals. RF usually refers to electrical rather than mechanical oscillations, although mechanical RF systems do exist.

As used herein, the term RF power divider refers to an apparatus or circuit that splits an RF signal path into more than one branch for subsequent distribution of an RF carrier signal to processing functions/circuits.

As used herein, the term random process refers to an uncountable, infinite, time ordered continuum of statistically independent random variables. A random process can also be approximated as a maximally dense time ordered continuum of statistically independent random variables.

As used herein, the term random variable refers to a variable quantity which is non-deterministic but can be statistically characterized. Random variables can be real or complex quantities.

As used herein, the term rendered signal refers to a signal which has been generated as an intermediate result or a final result depending on context. For instance, a desired final RF modulated output can be referred to as a rendered signal.

As used herein, the term sample refers to a representation of characteristics or parameters of an information bearing function of time. The characteristics or parameters can be physical or abstract quantities. One or more samples can be used to render a representation of an Information Bearing Function of Time. This representation can be a reconstruction or rendering or set of electronic data, that is based on a priori information of the information bearing function of time. Samples can be assigned sample values, scalars, vectors, tensors or other mathematical quantity. Sample values can have associated indices for maintaining order, sequence, or orderly reference purpose. One form of ordering or sequence control is time ordering.

As used herein, the term sample function refers to a set of functions which comprise arguments to be measured or analyzed. For instance multiple segments of a waveform or signal could be acquired (“sampled”) and the average, power, or correlation to some other waveform, estimated from the sample functions.

As used herein, the term scalar partition refers to any partition comprising scalar values.

As used herein, the term signal refers to an energetic information bearing function of time.

As used herein, the term signal efficiency refers to thermodynamic efficiency of a system accounting only for the desired output average signal power divided by the total input power to the system on the average.

As used herein, the term signal ensemble refers to a set of signals or set of signal samples or set of signal sample functions.

As used herein, the term single envelope refers to a quantity obtained from (a_{I}²+a_{Q}²)^{1/2} where a_{I} is the in phase component of a complex signal and a_{Q} is the quadrature phase component of a complex signal. a_{I} and a_{Q} can be functions of time.

As used herein, the term signal phase refers to the angle of a complex signal or phase portion of a(t)e^{-jω}^{_{c}}^{t+φ} where φ can be obtained from

$$φ = ( sign ) {tan}^{- 1} \frac{{a}_{Q}}{{a}_{I}}$$

and the sign function is determined from the signs of a_{Q}, a_{I} to account for the repetition of modulo tan a_{Q}/a_{I}

As used herein, the terms simplex, simplex communication, and one-way communication refer to a communication in which data, voice, or the like is transmitted in one direction only for a communications channel. For example, one or more locations receive, but cannot transmit. Other examples include broadcasting and that utilized by one-way intercom systems.

As used herein, the term spectral distribution refers to energy, power, amplitude, phase or some other relevant metric versus frequency with a statistical characterization.

As used herein, statistical partition refers to any partition with mathematical values or structures, i.e., scalars, vectors, tensors, etc., characterized statistically.

As used herein, the term steering refers to process of pointing or directing an antenna beam so that the beamwidth is primarily focused in a desired direction, for example a particular azimuth and elevation.

As used herein, the terms subharmonic, sub-harmonic, and sub harmonic refer to an integral submultiple of a first harmonic. For example, the third sub-harmonic of a 9 MHz harmonic is 3 MHz. For the purpose of this disclosure, a first sub harmonic is equivalent to the first harmonic and the same as the fundamental unless otherwise specifically indicated.

As used herein, the terms switch or switched refer to a discrete change in one or more values and/or processing path, depending on context. A change of functions can also be accomplished by switching between functions.

As used herein, the term symbol refers to a segment of a signal, usually associated with some minimum integer information assignment in bits or nats.

As used herein, the term “tensor partition” refers to any partition comprising tensors.

As used herein, the term thermodynamic efficiency (usually represented by the symbol η) is accounted for accounted for by application of the 1^{st} and 2^{nd} Laws of Thermodynamics:

$$η ≡ \frac{{P}_{out}}{{P}_{in}}$$

where Pₒᵤₜ is the power in a proper signal intended for the communication sink, load or channel. Pᵢₙ is measured as the power supplied to the communications apparatus while performing it's function. Likewise, Eₒᵤₜ and Eᵢₙ correspond to the proper energy out of an apparatus intended for communication sink, load, or channel, while Eᵢₙ is the energy supplied to the apparatus.

$$η ≡ \frac{{E}_{out}}{{E}_{in}}$$

As used herein, the term thermodynamic entropy refers to a probability measure for the distribution of energy amongst all degrees of freedom for a system. The greatest entropy for a system occurs at equilibrium by definition. Thermodynamic entropy is often represented with the symbol S. Equilibrium is determined when

$$\frac{d {s}_{tot}}{d t} \to 0.$$

“→” in this case means “tends toward”.

As used herein, the term thermodynamic flux refers to a concept related to the study of transitory and non-equilibrium thermodynamics. In this theory entropy can evolve according to probabilities associated with random processes or deterministic processes based on certain system gradients. After a long period, usually referred to as the relaxation time, the entropy flux dissipates and the final system entropy becomes the approximate equilibrium entropy of classical thermodynamics, or neo-classical statistical physics.

As used herein, the term thermodynamics refers to a physical science that accounts for the interaction of energy and matter. It encompasses a body of knowledge based on 4 fundamental laws that explain the transformation and transport of energy in a general manner.

As used herein, the undesired degree of freedom refers to a subset of degrees of freedom that gives rise to system inefficiencies such as energy loss or the non-conservation of energy and/or information loss and non-conservation of information. Loss here refers to unusable for its original targeted purpose.

As used herein, the term unit circle refers to a locus of points in the complex signal plane that lie on a circle with radius of unity and center located at the complex signal plane origin.

As used herein, the terms up-converter, up converter, and upconverter refer to a converter whose output frequency is higher than its input frequency. This contrasts with a down-converter, whose output frequency is lower than that of the input. A direct up converter converts a signal at baseband directly to a frequency with the RF fundamental as at least one of the frequency channels of its output spectrums.

As used herein, the terms variable energy source and variable energy supply refer to an energy source which can change values, with or without the assist of auxiliary functions, in a discrete or continuous or hybrid manner.

As used herein, the terms variable power source and variable power supply refer to a power source which can change values, with or without the assist of auxiliary functions, in a discrete or continuous or hybrid manner.

As used herein, the term vector partition refers to any partition comprising vector values.

As used herein, the term vector synthesis engine (VSE) refers to a processor that generates controls to implement the modulation process of the D2p™ and D2p™ AP complex up converters. A VSE can also generate the gain and phase control for branches of a multi-antenna element transmitter. A VSE can additionally or alternatively be used in conjunction with a D2d™ up conversion architecture.

As used herein, the term waveform refers to a particular instantiation of a function of time. A waveform is not required to be encoded with information.

As used herein, the term waveform efficiency refers to the efficiency calculated from the average waveform output power of an apparatus divided by its averaged waveform input power.

As used herein, the term work refers to energy exchanged between the apparatus and its communications sink, load, or channel as well as its environment. The energy is exchanged by the motions of charges, molecules, atoms, virtual particles and through electromagnetic fields as well as gradients of temperature.

As used herein, the term zero intermediate frequency (ZIF) refers to an RF receiver in which the frequency of the local oscillator signal is the same as the carrier frequency of the incoming signal and the resultant output of a received down conversion is centered at a frequency of zero Hz.

Sampled D2p™ and D2d™ Antenna Array Architectures

FIG. 3 is an illustration of an embodiment of a sampled D2p™ transmit antenna array architecture 300 that includes data stream 322, parallel clock/control 324, sampled D2p™ transmit modules 330₀-330ₙ, and antenna elements 340₀-340ₙ. Although FIG. 3 is depicted as having a certain number of sampled D2p™ elements, antenna elements, and corresponding data streams and parallel clocks/controls, embodiments of the invention support any suitable number of sampled D2p™ elements, antenna elements, and corresponding data streams and parallel clocks/controls.

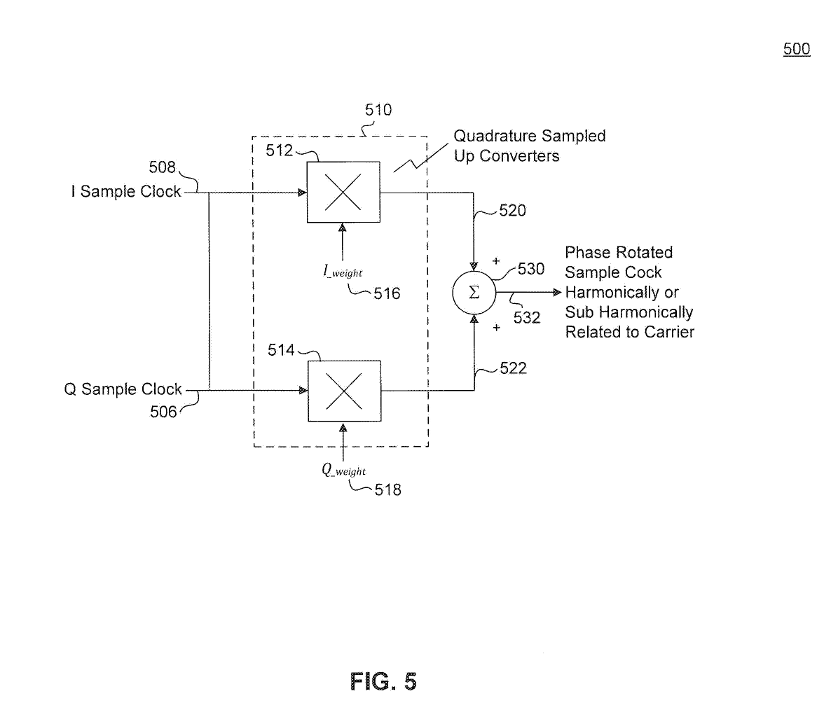

In an embodiment, the digital input data stream 322 is synchronously routed via parallel clock/control 324 and clock/control distribution network 324₀-324ₙ to separate sampled d2p transmit (TX) modulator modules 330₀-330ₙ (hereafter also referred to D2p™ modules or D2p™ AP™ modules, or TX modules) comprising converter functions, such as, for example, D2p™ up converter functions where the data is available on a parallel or serial bus instantiations 322₀-322ₙ to all TX branches. The D2p™ function in the up convert path can be supplanted by the D2d™ up converter technology as well. Thus it is understood that in any instantiation of a D2p™ up converter that is described in this disclosure that a D2d™ up converter can also be used. The clock/control distribution or distribution network 324₀-324ₙ (where “n” is any suitable number) can comprise one or more than one data control functions/signals, data clocking waveforms, gain and phase control, and sample clock, as well as multiple unique physical interface connections and conductors for each of up to n instantiations. The data (or digital information) 320 can be uniquely selected at each TX module (generally 330) or commonly accessed as specified for the application using one or more controls from the clock/control distribution (generally 324). The D2p™ modules (330) produce gain scaled and phase scaled RF carrier signals based on a sample clock, which can be harmonically or sub harmonically related to the desired output modulated RF carrier fundamental frequency and the various associated clock/controls 324₀-324ₙ and input data, or digital information 320. The outputs of D2p™ modules (330) are distributed to antenna elements 340₀-340ₙ. Information modulated onto the separate branch output signals can be identical or unique from branch to branch. In an embodiment, each D2p™ function can efficiently render a complex modulated RF signal at a specified power according to the D2p™ algorithm under distributed vector synthesis engine (VSE) (not shown in FIG. 3) control. The outputs can be used to form a steerable receive antenna beam using the distributed D2p™ algorithm in each branch. The carrier phase for each branch can be controlled by controlling the phase of the sampling clock using a complex phase shifter, such as the one illustrated in FIG. 5.

FIG. 4 is an illustration of an embodiment of a sampled D2d™ receive antenna array architecture 400 that includes receive antenna elements 402₀-402ₙ, (where “n” is any suitable number) LNA modules 404₀-404ₙ, (where “n” is any suitable number) D2d™ energy sampled array (down) converters 406₀-406ₙ, (where “n” is any suitable number) clocks 408₀-408ₙ, (where “n” is any suitable number) controls 410₀-410ₙ, (where “n” is any suitable number) baseband output interface/signals 412₀-412ₙ, post detection combiner module 414, digital information 416, and clock 418. Although FIG. 4 is depicted as having a number of receive antenna elements, LNA modules, D2d™ energy sampled array (down) converters, clocks, controls, and baseband output interface/signals, embodiments of the invention support any number of receive antenna elements, LNA modules, D2d™ energy sampled array (down) converters, clocks, controls, and baseband output interface/signals.

In an embodiment, each receive antenna element 402₀-402ₙ (where “n” is any suitable number) receives an RF signal that can be amplified via LNA modules 404₀-404ₙ. The outputs from the LNA in each receive branch are further processed by the D2d™ energy sampled array (down) converters 406₀-406ₙ (hereafter also referred to as D2d™ down converters). The down converters support ZIF, low IF or other suitable IF applications. Each D2d™ down converter (generally 406) has a baseband output interface/signals 412₀-412ₙ, which can be digital or analog format. In the complex down converter case, the baseband outputs are I and Q. The information can be correlated or unique at the output of each branch D2d™ down converter (406). Although FIG. 4 depicts a post detection combiner module 414, it is to be understood that post processing of the down converted signal can be accomplished in a number of ways including digitization and digital signal processing (DSP), or separate analog processors, with or without a combining function.

In embodiments in which a combining function is used, a signal 416 at the combiner output can be produced of the most desirable character to maximize performance of the communications link. The most desirable character can mean a representation of the received signal or signals with the highest signal to noise plus interference ratio (S/(N+I)), greatest information throughput with lowest probability of error, and highest reliability for link access and maintenance.

In an embodiment, the architecture can support a single receive information waveform distributed amongst the antenna elements or multiple uniquely processed information waveforms.

In an embodiment, gain weighting and phase shifting in each branch can be accomplished within or in conjunction with the D2d™ down converter module in the example illustrated in FIG. 4. The D2d™ down conversion process can use a sub harmonic (sub harmonic with respect to the fundamental received carrier frequency) waveform referred to as a sample clock. The phase of this clock is controlled by the phase shifting process illustrated in FIG. 5 within the converter modules 406₀-406ₙ. Gain can be weighted in part or whole within or in conjunction with the modules generally 406₀-406ₙ, or some weighting and scaling can be applied in post processing of signals 406₀-406ₙ, thus permitting the greatest flexibility in receiver algorithms. Likewise, time alignment of the down converted signals 406₀-406ₙ can be further controlled with post processing.

In an embodiment, the architecture illustrated in FIG. 4 can be used to steer the beam of the receive antenna array or to access diversity properties of the receive antenna elements, or to support MIMO applications or some blend of options which are configurable or dynamically controlled.

### Gain and Phase Control

There are at least two methods of digital gain adjustments which are possible per processing branch, where a processing branch is considered as the transmit or receive information signal path for an energy sampled D2p™ array processor (also referred to herein as “D2p™ AP”) and/or a sampled D2d™ array processor (also referred to herein as “d2dAP”).

Gain of a particular processing branch can be adjusted by the digital weight of analog-to-digital (A/D) conversion in the information path and/or a sample aperture width. Typically, the A/D information path will comprise I (In-Phase) and Q (Quadrature Phase) signals. The magnitude of these signals can be adjusted by rescaling maximum values as some back-off from the most significant magnitude bit or reducing average powers or some combination of the two techniques.

Some number of gain magnitude bits can be allocated to the up or down conversion sampling time aperture width. Gain is maximum for a specific sampling aperture width. At other aperture widths which deviate away from the optimal conversion aperture (specifically designed for a maximum gain), gain can decrease.

Phase of the carrier in each processing branch can also be adjusted modulo 360° with respect to a carrier reference phase. This is accomplished via a harmonic or sub harmonic sample clock and a complex sampler. The sample clock frequency is related to the carrier frequency by:

sample clock frequency=n·(carrier frequency), where n=1,2,3, . . .

f_{clk}=n·f_{c}, where n=1,2,3, . . .

or

sample clock frequency=(carrier frequency)/N; where N=1,2,3, . . .

f_{clk}=f_{c}/N; where N=1,2,3, . . .

The phase of the harmonic or sub harmonic clock, where harmonic and sub harmonic are determined by the values n, N, respectively, is rotated around the unit circle of the complex plane by digital weighting of I and Q control.

There are at least two implementations for changing the relative carrier phases of each processing branch: direct and vector decomposition. The direct method is illustrated in FIG. 5.

FIG. 5 is an illustration of an embodiment 500 of a direct sample clock phase shifter. In an embodiment, in phase (I) and quadrature (Q) sample clock waveforms are input to two sampler or multiplier 512, 514 (also referred together using reference numeral 510) as shown by inputs 508 and 506. The I and Q sample clock waveform inputs 508 and 506, respectively, can be generated from a suitable higher frequency clock using digital divider circuitry, quadrature generating network or other suitable means. Sample clocks 508 and 506 are orthogonal clocks at harmonic or sub harmonic rates. I_weight 516 and Q_weight 518 inputs to the samplers or multipliers (512, 514, respectively). The inputs 506 and 508 are scaled so that the multiplier outputs 520 and 522 to generate appropriately weighted quadrature clocks. The orthogonal clock waveforms can also be viewed as time variant quadrature vectors. Outputs 520 and 522, of sampling modules 512, 514, respectively, are summed at summing module 530. The output of the summer module 530 is signal 532, which is a single phase rotated sample clock or sampling waveform which is at a harmonic or sub harmonic frequency related to the carrier, depending on application. The summing module 530 is a circuit, or circuitry, that receives at least one input signal and produces a signal that is a function of the received one or more input signal(s).

FIG. 6 is an illustration 600 of an example complex phasor representing phase rotated sample clock, in accordance with one or more embodiments. In an embodiment, the relationship of carrier phase, φ, and I_{—weight}, Q_{—weight} are given by:

$$\sqrt{{( {I}_{\_ weigh t} )}^{2} + {( {Q}_{\_ weigh t} )}^{2}} = constant ( ‘ 1 ’ for example )$$

$${φ}_{{H}_{c}} = n \{ arc tan [ \frac{{Q}_{\_ weight}}{{I}_{\_ weight}} ] \} [ sign \{ {Q}_{\_ weight} , {I}_{\_ weight} \} ]$$

$${φ}_{{SH}_{c}} = \frac{1}{N} \{ arc tan [ \frac{{Q}_{\_ weight}}{{I}_{\_ weight}} ] \} [ sign \{ {Q}_{\_ weight} , {I}_{\_ weight} \} ]$$

where φ_{H}_{_{c}} is the phase of a harmonic carrier for n=1, 2, 3, . . . and n fc=fclk or φ_{SH}_{_{c}} is the phase of a sub harmonic carrier for N=1, 2, 3, . . . and f_{c}/N=f_{clk}.

In an embodiment, the function sign {Q_{—weight}, I_{—weight}} is a function which tracks the polarity of in-phase and quadrature phase weights to determine in which quadrant the output complex phasor 608 resides on account of the ambiguity of the arctan function. The “direct” method creates a complex phasor illustrated in the complex plane by FIG. 6.

Output complex phasor 608 is a rotating vector also called a complex phasor or simply phasor for the purposes of this disclosure. The unit circle 606 is a particular locus of points on the circle of radius unity with a center at the origin 612 of the complex plane. I-axis 602 and Q-axis 604 show arbitrary reference axes, set to zero degrees for illustration purposes. A circle radius of less than or greater than unity is possible as well and can be adjusted by the sample clock duty cycle/sampling aperture width as well as suitable gain weighting of the input orthogonal clock waveforms. The complex phasor 608 is composed of the real and imaginary component vectors formed from the I_weight and Q_weight and sampler or multiplier functions of FIG. 5.

By suitable choice of I_{—weight}, Q_{—weight} and sign {Q_{—weight}, I_{—weight}}, any phase φ_{SH}_{_{c}}, φ_{SH}_{_{c}} 610 can be achieved modulo 360°. The phase rotated sample clock can then be used for up conversion and/or down conversion of a signal which possesses a carrier phase, rotated relative to some specified reference. Each processing thread (or architectural branch) can possess a unique and separately controlled relative phase, φ_{H}_{_{c}} or φ_{SH}_{_{c}} 610.

Example D2p™ AP™ and D2d™ AP Modules

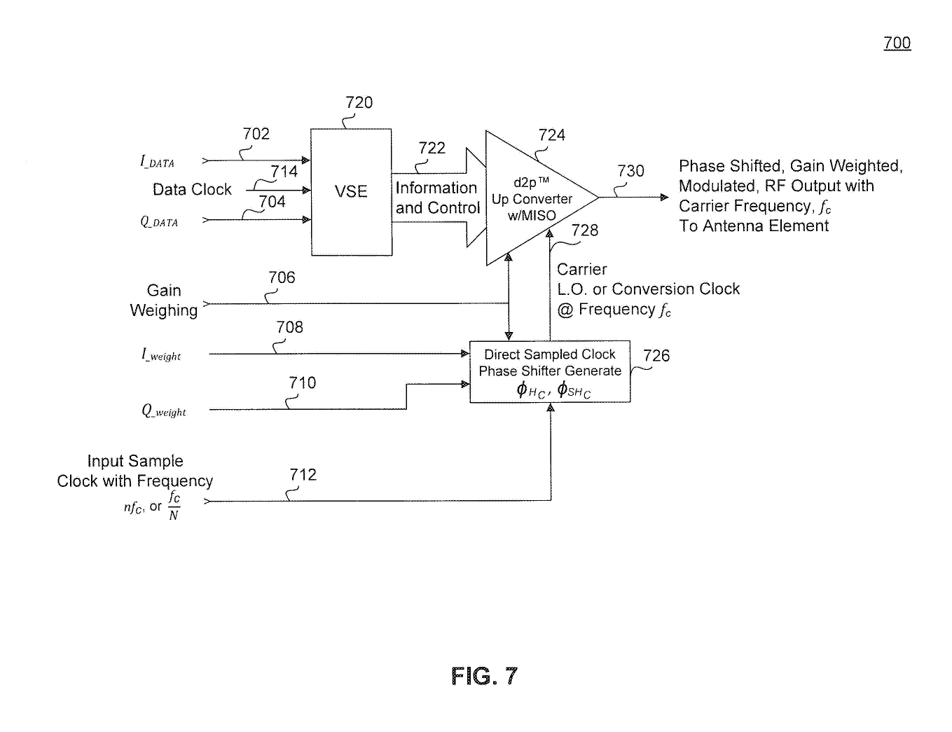

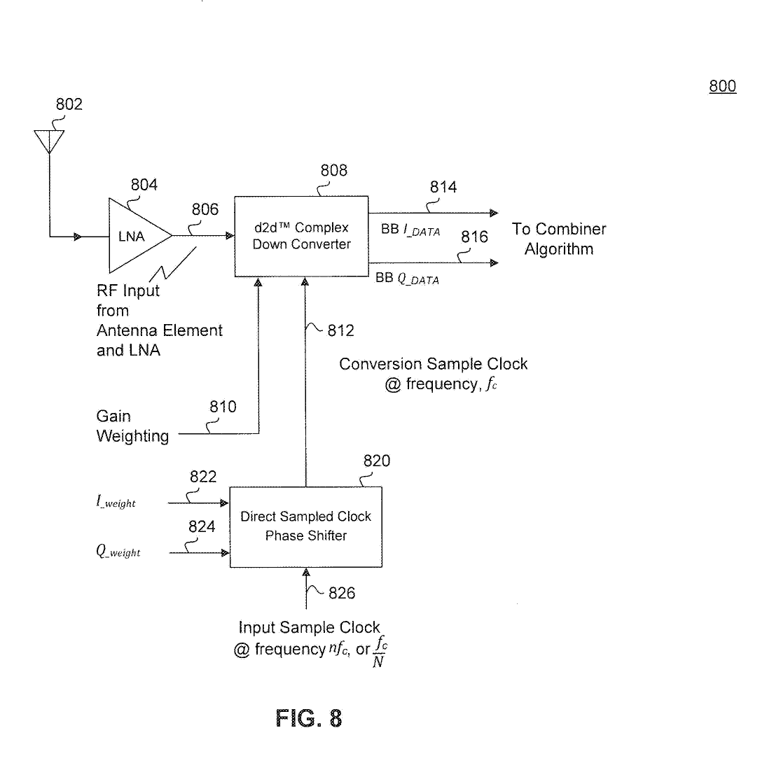

FIGS. 7 and 8 illustrate the relationship of the D2p™AP and D2d™AP module signal inputs, outputs, and sample clocks.

FIG. 7 is an illustration 700 of an embodiment of a D2p™ AP™ module. In FIG. 7, the gain and phase weighted transmit carrier at output 730 is formed for one up conversion branch that supplies at least one antenna element or cluster of elements with a complex modulated up converted RF signal. I_Data 702 and Q_Data 704 are information inputs. Data clock 714 is a data clock used for clocking the information into a vector synthesis engine (VSE) 720. The VSE 720 calculates the proper vector rotation and gain requirements for the array element or cluster of elements and distributes the vector control with distributed information/control information 722 to the D2p™ up converter circuitry 724, which can also include MISO circuitry. The D2p™ up converter circuitry 724 generates the modulated RF signal from the conversion clock signal 728 and the distributed information/control information 722. The information can be information/data to be conveyed in a simplex, half duplex, or full duplex communication and the control (control information) steers the antenna. The conversion clock signal 728 is the clock formed by the process described in FIGS. 5 and 6 or associated disclosures. Module 726, as well as various signals/inputs 708 (I-weighting), 710 (Q-weighting), 712 (input sample clock with a frequency component) corresponds to the associated items of FIG. 5. An additional gain weight 706 is provided to assist the RF weighting of each path or cluster. One method of gain control/scaling (corresponding to the input of gain weight 706 to module 726) is to adjust the sampling aperture and/or duty cycle of the sampling up conversion clock signal 728. Another scaling method (corresponding to the input of gain weight 706 to converter circuitry 724) adjusts the gain of complex modulation functions within the d2p circuits/algorithm. Such circuits/algorithms enable a plurality of signals to be individually amplified, then summed to form a desired time-varying complex envelope signal. Phase and/or frequency characteristics of one or more of the signals are controlled to provide the desired phase, frequency and/or amplitude characteristics of the desired time-varying complex envelope signal. Additionally, a time-varying complex envelope signal is decomposed into a plurality of controlled envelope constituent signals. The constituent signals are amplified equally, or substantially equally and then summed to construct an amplified version of the original time-varying envelope signal. Furthermore, the circuits/algorithms are adapted to modulate and on-frequency power amplify signals. Indeed, the signals can also be combined using a multiple input, single output (MISO) circuit. U.S. Pat. Nos. 6,091,940, 6,740,549, 7,039,372, 7,050,508, 7,355,470, 7,184,723, 8,502,600, 7,647,030, 8,013,675, and 8,433,264 provide additional detail concerning the processing algorithms associated with VSE 720, D2p™ up converter circuitry 724, D2p™, and MISO, and the contents of which are hereby incorporated herein by reference in their entireties.

FIG. 8 is an illustration of an embodiment 800 of a D2d™ AP module and shows an example D2d™ complex down converter 808 branch. This example includes a single receive antenna element 802 providing a RF input to an LNA 804. (While a single antenna element 802 is shown, it is an alternate embodiment of the present invention to use a plurality of antenna elements.) The amplified signal 806 is an input to the down converter 808. The sample clock input 812 is produced by direct sampled clock phase shifter module 820. Sample clock input signal 812 can be formed from the process described in FIGS. 5 and 6. Module 820 and inputs 822 (I-weight), 824 (Q-weight), and input sample clock at a selected frequency 826 can be provided in accordance with the various functions used to generate the phase shifted down conversion sample clock discussed regarding FIGS. 5 and 6. In addition a gain weighting 810 is provided to control the gain scaling of the complex down conversion path. In an embodiment, the method of gain scaling is adjustment of the sampling aperture/duty cycle of the sampling down conversion clock 812. Alternatively, another method is to directly adjust the gain or the complex D2d™ down conversion path. This involves accepting a modulating baseband signal and generating a plurality of redundant spectrums. Each redundant spectrum includes the necessary amplitude, phase and frequency information to substantially reconstruct the modulating baseband signal. Additional processing details of a D2d™ complex down converter 808 are disclosed in U.S. Pat. Nos. 6,061,551, 7,194,246, 7,218,907, 7,865,177, and 8,190,116, the contents of which are hereby incorporated herein in their entireties. The converter module 808 generates, or produces, baseband I-data signal 814 and baseband Q-data signal 816. The baseband I 814 and baseband Q 816 can be provided to a combiner algorithm.

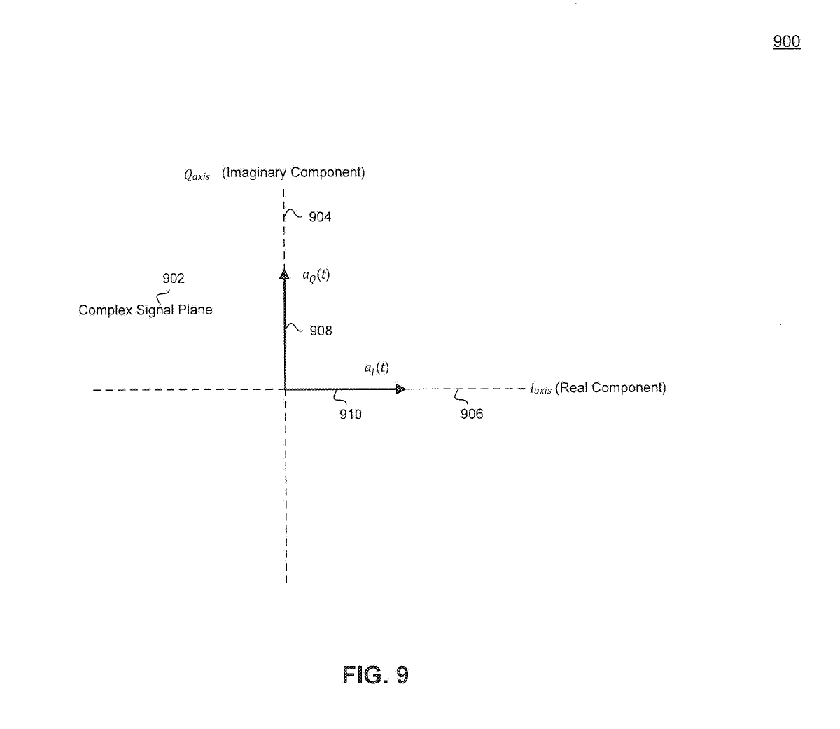

FIG. 9 is an illustration 900 of an example complex signal plane decomposition of in-phase and quadrature phase signals at 0° reference carrier phase rotation. Complex signal plane 902 is the plane that the shift is shown. In an embodiment, relative transmitter RF carrier phase shifts between antenna elements or signal processing branches can be created using vector decomposition and virtual rotation using I/Q vector projections from a separate I component 910 (along the real axis 906) and a separate Q component 908 (along the imaginary axis 904), which can also be referred to as components of the decomposition. The pair of modulated I/Q vectors can also be referred to as a complex signal plane view of a 0° shifted in-phase and quadrature phase modulated carriers. The vector sum of a_{I}(t) and a_{Q}(t) produces a resultant time variant vector in the complex plane quadrants depending on the signs and magnitudes of a_{I}(t) and a_{Q}(t).

a_{Q}(t) is a time variant quadrature control which varies the complex signal envelope of the signal S(t). a_{I}(t) is a time variant in-phase information or data stream which modulates the complex signal envelope of S(t). S(t) is therefore given by:

S(t)=a_{I}(t)cos(ω_{c}t+φ_{c}(t))±ja_{Q}(t)sin(ω_{c}t+φ_{c}(t)), where
a_{I}(t) is time variant in-phase BB (baseband) control information;
a_{Q}(t) is time variant quadrature BB (baseband) control information;
ω_{c} is a clock signal frequency in radians/second;
φ_{c} is a clock signal phase 1010 in radians; and
f_{c} is equal to (ω_{c}/2π), clock signal frequency in Hz.

F_{c} and φ_{c} can be obtained by using harmonic or sub harmonic frequencies as previously discussed.

In an embodiment, it is possible to generate relative phase shifts of S(t) by suitably choosing a fixed offset value for φ_{c}. The ± sign terms for the quadrature component a_{Q} is a matter of convention for the preferred direction of rotation of the vector and/or the preferred definition for positive or negative angle offset or carrier phase, φ_{c}. The complex number j has been included to contemplate the complex exponential form of the equation as an optional mathematical representation.

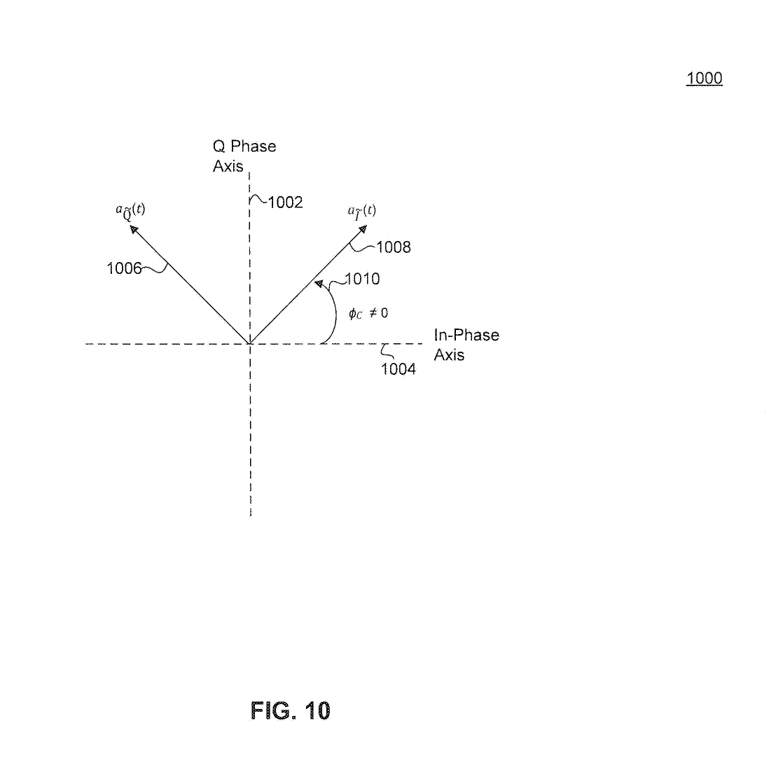

FIG. 10 illustrates an example 1000 of a rotated (phase shifted) complex vector signal. Q-axis 1002 and I-axis 1004 are used as reference axes. The rotated complex vector signal is identical to that of FIG. 9 except for φ_{c} 1010, the rotation angle or offset angle of the clock waveform relative to the carrier.

The control signals a_{\tilde{Q}}(t) 1006 and a_{Ĩ}(t) 1008 signals, which are orthogonal to one another, can be given in terms of the original S(t) formulation for a given phase angle φ_{c}.

ã_{Q}(t)=a_{\tilde{Q}}(t)cos(φ_{c})+a_{Ĩ} cos(π/2−φ_{c})

ã_{I}(t)=a_{\tilde{Q}}(t)cos(π/2−φ_{c})+a_{Ĩ} cos(φ_{c})

In an embodiment, \tilde{S}(t) is given by:

\tilde{S}(t)=ã_{I}(t)cos(ω_{c}t)±jã_{Q}(t)sin(ω_{c}t)

\tilde{S}(t) is then a phase shifted version of S(t) implemented by suitable definition of I and Q components rather than direct phase sifting of the carrier clock. In this realization, the direct sampled clock phase shifter of FIG. 7 can be omitted or can also be included.

The process of controlling or resolving the ã_{I} and ã_{Q} components, as well as φ_{c}, applies to both up conversion and down conversion schemes discussed with regard to FIGS. 7 and 8. In this manner the phase and complex weighting factors for each antenna element or cluster of antenna elements can be controlled independently to transmit or receive any complex waveform at the antenna array.

Example D2d™ Complex Down Converter

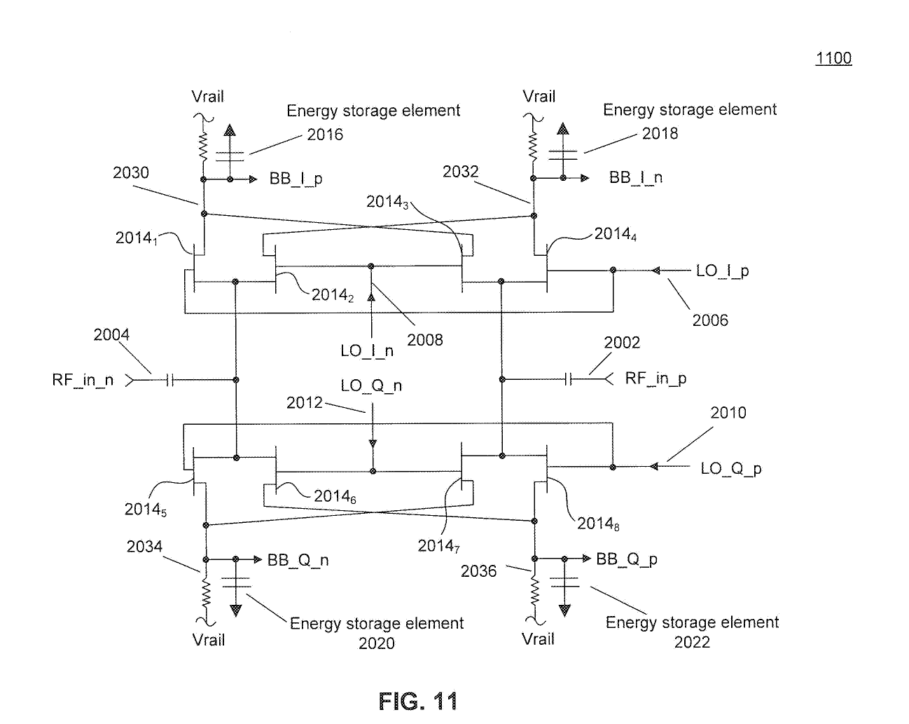

FIG. 11 illustrates an embodiment of a D2d™ complex down converter 1100. A D2d™ complex down converter can be all or part of the D2d™ complex down converter 808 described with regard to FIG. 8. Although FIG. 11 depicts a differential architecture, embodiments support single-ended architectures. Alternate realizations and more comprehensive theory of operation discussions are disclosed in U.S. Pat. Nos. 6,061,551, 7,194,246, 7,218,907, 7,865,177, and 8,190,116, the contents of which are hereby incorporated herein by reference in their entireties.

In an embodiment, a differential RF inputs RF_{—in—p} 2002 and RF_{—in—n} 2004 are applied to the down converter input, such as, for example, the RF modulated carrier signal 806 of FIG. 8. The inputs LO_{—i—p} 2006 and LO_{—i—n} 2008 are differential I phase down conversion sample clocks. The inputs labeled as LO_{—Q—p} 2010 and LO_{—Q—n}, 2012 are differential Q phase down conversion sample clocks. These conversion clocks correspond generally to conversion sample clock 812 of FIG. 8. Transistors (generally 2014) are used to perform a gating function for energy storage elements, for example, these can be capacitors or some other substantially non dissipative passive electronic circuit network of components, 2016, 2018, 2020 and 2022. Energy sampling can include a method or circuit which acquires and conveys samples of a modulated carrier signal while optimizing SNR of the samples and conserving information conveyed by the samples. Samples are conveyed (down converted) from the RF carrier frequency through aliasing while transferring substantial energy from the carrier to a low IF or baseband frequency in the sampling process. The outputs BB_{—I—p} 2030 and BB_{—I—n}, 2032 are the down converted I baseband (ZIF) or lower frequency (IF) signal. The quadrature outputs BB_{—Q—p} 2034 and the output BB_{—Q—n}, 2036 are the down converted Q baseband (ZIF) or lower frequency (IF) signal.

The example down converter of FIG. 11 receives a conversion sample clock at frequency f_{c}/N where N=1, 2, 3, . . . . The RF input from an LNA or array element, or power divider attached to LNA's or array elements, can be down converted by the sample clocks which can possess variable or fixed aperture widths and/or variable or fixed duty cycle. The baseband outputs of the down converter BB_{—I—p} 2030, BB_{—I—n} 2032, BB_{—Q—p} 2034, and BB_{—Q—n}, 2036 can be digitized or left in analog form.

In embodiments in which the outputs are digitized, the outputs can be multiplexed in parallel or serial formats on digital distribution busses for subsequent DSP or baseband processor processing. The subsequent processing can comprise “proper combining” with other down converted paths, DC offset removal or reduction, filtering, additional demodulation, decoding, etc. “Proper combining” means that the various array element receive processing paths can be integrated to form a down converted path with superior signal to noise plus interference power ratios, (S/(N+I)), while preserving the information metrics of the down converted signal. Superior means a more preferable signal compared to the case of down conversion using a single antenna element processing path. Similar to the foregoing discussion, processing can also be accomplished using analog functions at baseband or near baseband, in part or whole.

In an embodiment, the down conversion from RF can be to zero IF or as close to an IF of DC as is practical given the preferred or available support hardware and software function limitations and configurations. Other suitable IF frequencies can also be supported depending on the harmonic or subharmonic clock frequency. For instance, a convenient lower frequency IF signal can be used in the down conversion such that the BB processor or DSP can complete the carrier stripping, synchronization and demodulation, DC offset removal procedures, etc., without requiring perfect phase and/or frequency synchronism between down conversion clocks and the received RF carrier.

Example D2p™ Complex Up Converter

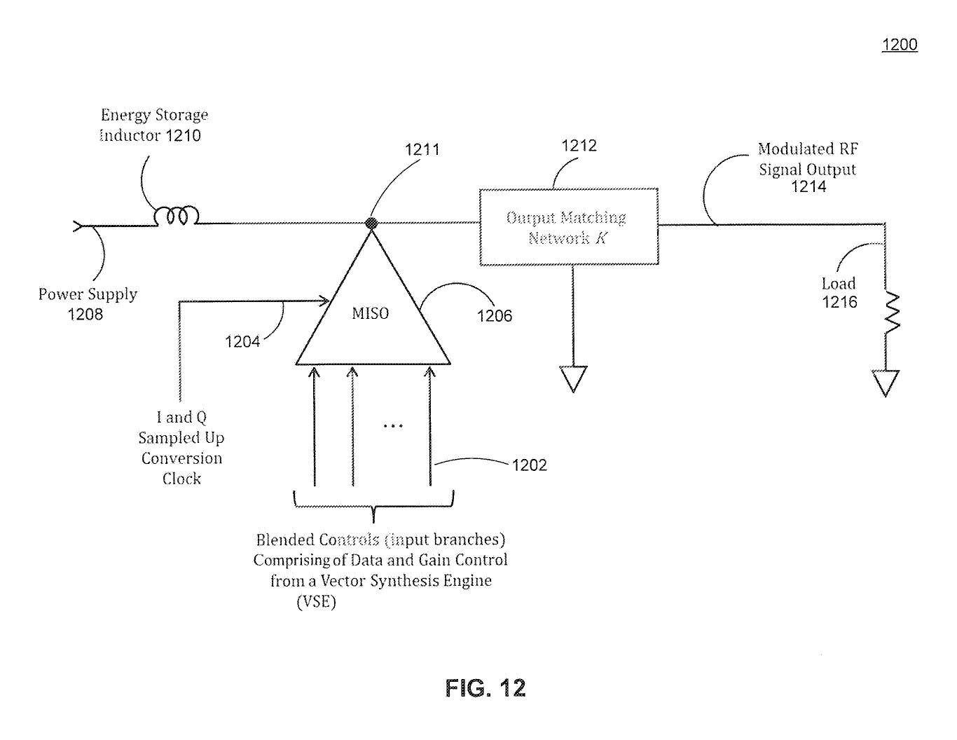

FIG. 12 illustrates an embodiment 1200 of a D2p™ complex up converter. In an embodiment, the complex up converter can be used as part of the example D2p™ AP™ module of FIG. 7. A D2p™ upconverter can include a method or circuit which acquires and conveys samples of a baseband signal and modulates information conveyed by the samples onto a carrier. Samples are conveyed (up converted) from the BB frequency through harmonic sampling images while transferring substantial energy from the BB to a modulated carrier frequency in the sampling process.

In an embodiment, the D2p™ complex up converter comprises active and passive circuits operated in linear and nonlinear modes depending on the distributed controls 1202 from the VSE (not shown in FIG. 12). The multiple input single output operator (MISO) module 1206 provides a composite representation of the blended inputs 1202 at an output 1211. The input signals 1202 can be derived from one or more input branches and/or data and gain control signals from a VSE, or other module that is adapted to generate blended controls, data signals, gain control signals or other suitable input signals for MISO module 1206. The MISO module 1206, along with surrounding networks and VSE, blends linear and nonlinear functions of the distributed controls 1202 and inputs 1204 which are dynamically weighted to achieve the desired output signal. The input signals 1204 are I and Q sampled up-conversion clock signals that are provided to MISO module 1206. The distributed information of the MISO inputs is conserved in the process so that the modulated output signal at a desired RF channel and at a specified power preserves the encoded information while achieving a desired standard or targeted output signal 1214 requirement in an efficient manner. The efficiency is improved over traditional power amplifier technology approaches through the use of the compositing algorithms of the VSE (for example, VSE 720 of FIG. 7) in conjunction with other D2p™ hardware, including each branch of the MISO input and the MISO as well as surrounding energy storage networks. As shown in FIG. 12, a power supply 1208 can be used to provide one or more additional power signal(s) to node 1211. The one or more power signals from power supply 1208 can be modified, stored, or held by energy storage inductor 1210. The holding or storage can be temporary and the duration of the hold or storage is a function of inductor characteristics and power signal characteristics as well as other circuit 1200 parameters and circuit element values. The power signal and output from MISO 1206 is provided to output matching network 1212. The output from module 1212 is a modulated RF signal 1214 that can be provided to load 1216. Load 1216 can be for example, any electrical component or portion of a circuit that is connected to a signal source. In this example, load 1216 receives signals 1214. The output matching network 1212 can be for example, circuitry, or one or more electronic components, that are designed to maximize power transfer or minimize signal reflection from the load 1216. The output matching network 1212 is an enhancement to the circuit 1200 and is not required for the circuit 1200 to function according to the design parameters.

In an embodiment, at least two branches of the MISO inputs (1202, 1204) are generated by sub harmonic or harmonic sampling, or some combination of both sampling frequencies, for example I and Q sampled up conversion clocks 1204 (also referred to as sample clocks 1204). The sample apertures of the sample clocks 1204 can be controlled or sculpted in terms of amplitude, phase, rise times, fall times, and pulse width. Sample clocks 1204 can be phase shifted by the methods discussed with regard to FIG. 5, as well as using other techniques described herein. The pulse width of these clocks can also be used for gain scaling. Additionally, a linear complex up converter can be used in the MISO. This use can be enhanced by sculpting the branch processing following the up conversion process. In this context, suitably sculpted means that the signals are designed to trade off information content versus efficiency per branch so that a composite signal is optimized against some performance metric blend at the output 1211 of the MISO and energy storage 1210 and/or filter networks (filter networks not shown in FIG. 12) and load 1216. Load 1216 can be an RF load, or other signal receiving circuit or portion of a circuit. The performance metrics of the circuit 1200 comprise efficiency, modulation content, output power, and signal quality. Signal quality refers to any combination of EVM performance, ACPR performance, spectral distribution performance, harmonic content performance, etc.

In an embodiment, both gain and phase of the up converted signal are individually controlled to enable a phased array, diversity, or MIMO antenna application.

In some embodiments, the D2p™ complex up converter employs D2p™ techniques disclosed in U.S. Pat. Nos. 6,091,940, 6,740,549, 7,039,372, 7,050,508, 7,355,470, 7,184,723, 8,502,600, 7,647,030, 8,013,675, and 8,433,264, the contents of which are hereby incorporated herein by reference in their entireties.

Example D2d™ Complex Up Converter

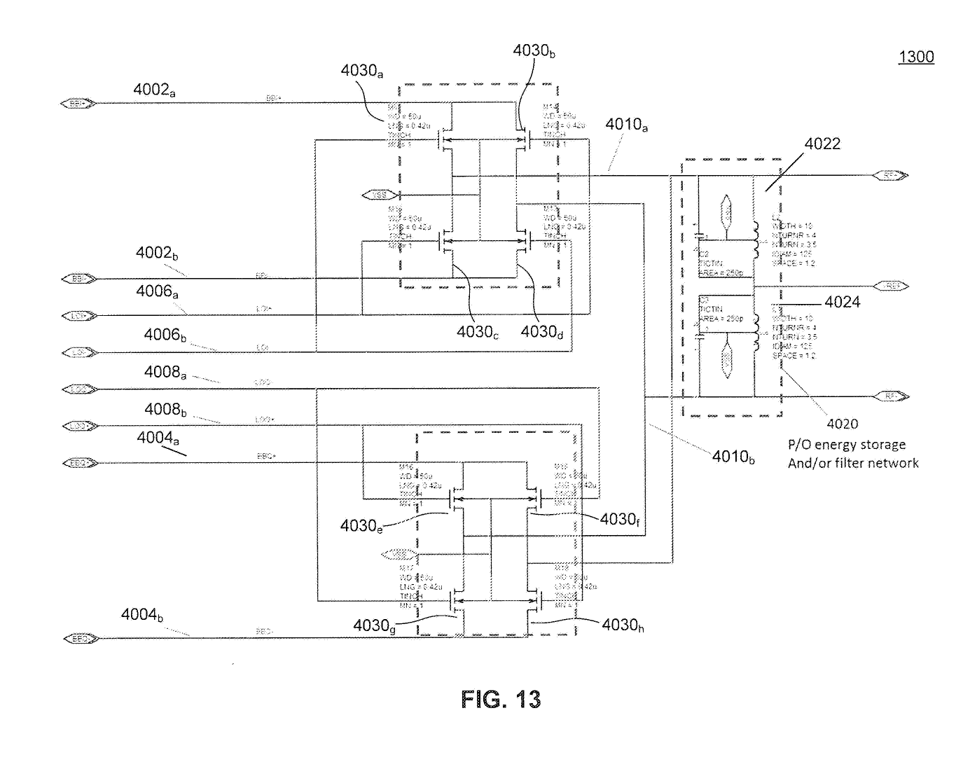

FIG. 13 illustrates an embodiment 1300 of a complex sampled up converter using a D2d™ core in reverse, also referred to as a D2d™ up converter. Although FIG. 13 depicts particular values for circuit components, these values are illustrative and embodiments are not limited to these particular values and support other values. Indeed, any suitable values can be used and the discussion herein is merely one embodiment of the present invention. The D2d™ complex up converter can be used other embodiments discussed herein. For example, the D2d™ complex up converter can be in the systems discussed herein as a substitute for D2p™ based up converters. In some embodiments, the form of the VSE can change, and conventional DSP BB circuits can be used in lieu of a VSE.

In an embodiment, the I data streams (BBI+ 4002ₐ and BBI− 4002_{b}) and Q data streams (BBQ+ 4004ₐ and BBQ− 4004_{b}) data streams are independently sampled at a sub harmonic or harmonic frequency with a suitable sample aperture. In an embodiment, the sample apertures can be controlled or sculpted in terms of amplitude, phase, rise times, fall times, and pulse width (e.g., aperture width in time). The sampling aperture can be tailored to optimize power transfer to an energy storage network 4020, which can include energy storage module 4022 and/or suitable output filter 4024 to assist in the generation of the modulated RF output signals RF+ 4010ₐ and RF− 4010_{b} with desirable (designed or specified) spectral characteristics. The sampling apertures are associated with the pulse widths of the sampling waveforms and/or sampling signals LOI+ 4006ₐ and LOI− 4006_{b} (collectively signals 4006) and LOQ+ 4008ₐ and LOQ− 4008_{b} (collectively signals 4008). The indicated schematic values are example values, and embodiments are not limited to these values. Signals 4006 and 4008 can be 25% duty cycle clocks.

In an embodiment, the sampling signals 4006 and 4008 can be suitably sculpted to help achieve an overall output signal performance. In this context, suitably sculpted means that the signals are designed to trade off spectral content, as well as information content versus efficiency per branch so that a composite signal is optimized against some performance metric blend at the output of the MISO (not shown in FIG. 13) and energy storage and/or filter networks and RF load (not shown in FIG. 13). The performance metrics comprise efficiency, modulation content, output power, and signal quality. Signal quality refers to any combination of EVM performance, ACPR performance, spectral distribution performance, harmonic content performance, etc. Transistors (generally 4030) are grouped in transistor modules for example, transistors 4030a-d are in a first transistor module and transistors 4030e-h are in a second transistor module. The first transistor module receives signals 4002a, 4002b, 4006a and 4006b. Second transistor module receives signals 4008a, 4008b, 4004a and 4004b. The interaction between the two transistor modules generate signals 4010a and 4010b that are provided to RF+ and RF− signals to energy storage and filter network 4020, which includes energy storage module 4022 and filter module 4024.

In an embodiment, both gain and phase of the up converted signal are individually controlled to enable a phased array, diversity, or MIMO antenna application.

In some embodiments, the D2d™ complex up converter employs D2d™ techniques disclosed in U.S. Pat. Nos. 6,091,940, 6,740,549, 7,039,372, 7,050,508, 7,355,470, 7,184,723, 8,502,600, 7,647,030, 8,013,675, and 8,433,264, the contents of which are hereby incorporated herein by reference in their entireties.

D2d™ Complex Down Converter

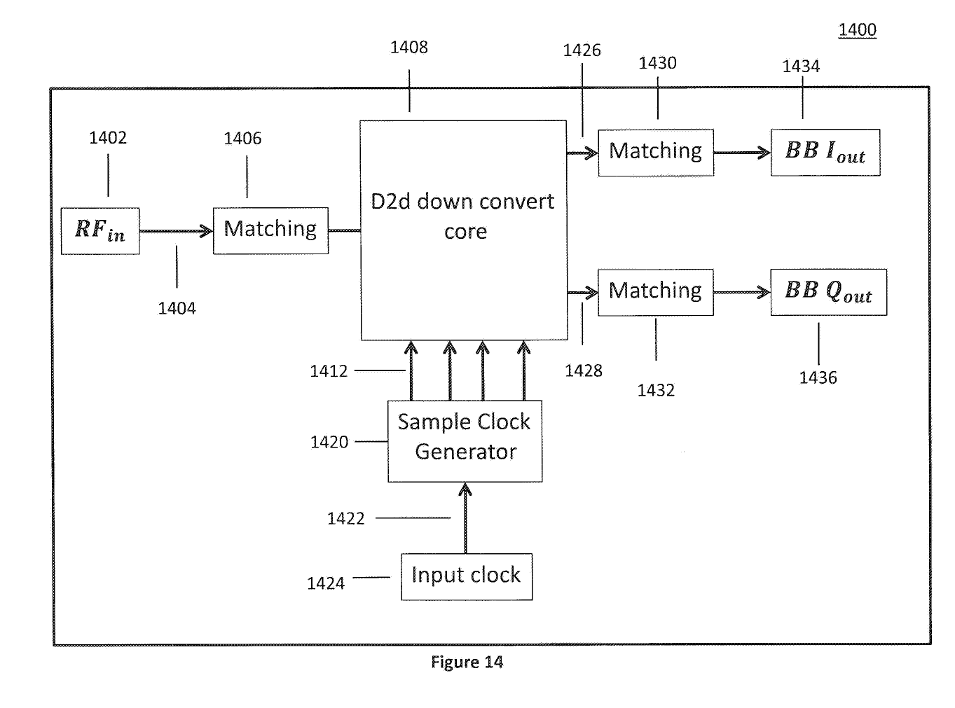

FIG. 14 illustrates an embodiment of a D2d™ complex down converter 1400. This example includes a single RF input signal 1402 providing a RF input to an matching module 1404. This matching module 1404 can be an impedance or load matching circuit, circuitry, circuit elements, networks, or any combination thereof. While a single RF input signal 1402 is shown, it is an alternate embodiment of the present invention to use a plurality of RF input signals. The matched signal 1406 output from matching module 1404 is provided to the down converter 1408. One or more sample clock inputs (generally 1412) are produced by sample clock generator module 1420. Sample clock inputs 1412 can be formed from the process described in FIGS. 5 and 6. Sample clock generator module 1420 receives input clock signals 1422 from input clock 1424. The input clock signals 1422 can include, for example, I components, Q components, input sample clock at a selected frequency, data signals, information signals, waveforms, or any combination thereof.

Down converter 1408 generates lower frequency output signals 1426 and 1428, corresponding to downconverted I and Q signals, respectively. Signals 1426 and 1428 can be matched using matching modules 1430 and 1432 to produce matched outputs BBI_out 1434 and BBQ_out 1436. The matching modules 1430 and 1432 are optional and can be used to optimize or enhance downconverted signals 1426 and 1428. Matching modules 1430 and 1432 can be an impedance or load matching circuit, circuitry, circuit elements, networks, or any combination thereof.

Additional processing details of a D2d™ complex down converter 1408 are disclosed in U.S. Pat. Nos. 6,061,551, 7,194,246, 7,218,907, 7,865,177, and 8,190,116, the contents of which are hereby incorporated herein in their entireties.

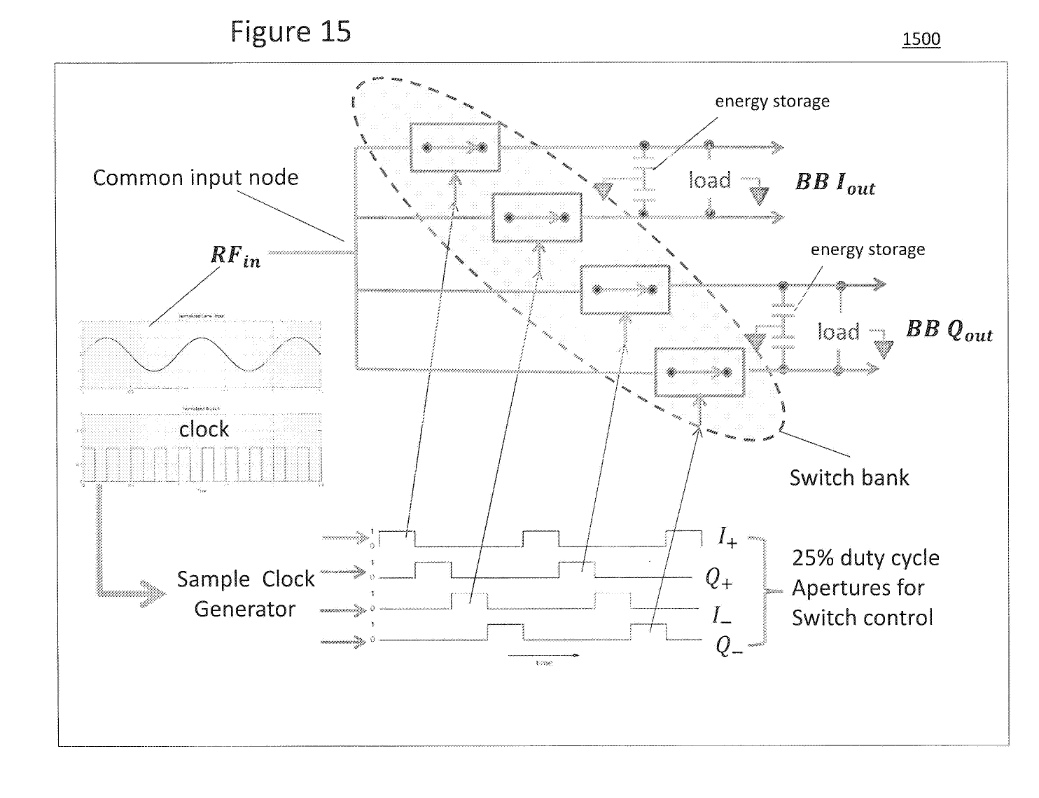

FIG. 15 illustrates an embodiment of a 25% duty cycle D2d™ complex down converter 1500. An RF input signal is provided to the circuitry controlled by a sample clock generator that has a 25% duty cycle and apertures for switch control. As shown, BBI_out (+ and −) and BBQ_out (+ and −) are generated by this downconverter.

D2d™ Complex Up Converter

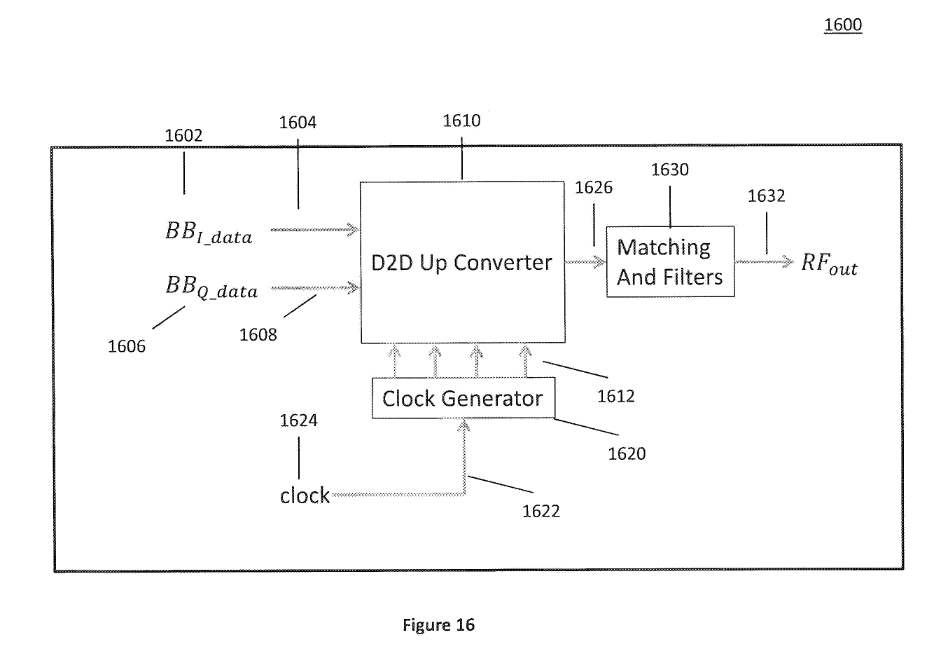

FIG. 16 illustrates an embodiment of a D2d™ complex up converter 1600. D2d™ upconverter 1600 includes a BB_I_data source 1602 that provides BB_I_data signal 1604 to D2d™ up converter module 1610. D2d™ upconverter 1600 also includes a BB_Q_data source 1606 that provides BB_Q_data signal 1608 to D2d™ up converter module 1610. One or more sample clock inputs (generally 1612) are produced by sample clock generator module 1620. Sample clock inputs 1612 can be formed from the process described in FIGS. 5 and 6. Sample clock generator module 1620 receives input clock signals 1622 from input clock 1624. The input clock signals 1622 can include, for example, I components, Q components, input sample clock at a selected frequency, data signals, information signals, waveforms, or any combination thereof.

Up converter 1610 generates a higher frequency output signal 1626, which includes the upconverted I and Q signals. Signal 1626 can be matched using matching module 1630 to produce matched output RF_out 1632. The matching module 1630 is optional and can be used to optimize or enhance upconverted signal 1626. Matching module 1630 can be an impedance or load matching circuit, circuitry, circuit elements, networks, or any combination thereof.

Additional processing details of a D2d™ complex up converter 1608 are disclosed in U.S. Pat. Nos. 6,091,940, 6,740,549, 7,039,372, 7,050,508, 7,355,470, 7,184,723, 8,502,600, 7,647,030, 8,013,675, and 8,433,264, the contents of which are hereby incorporated herein in their entireties.

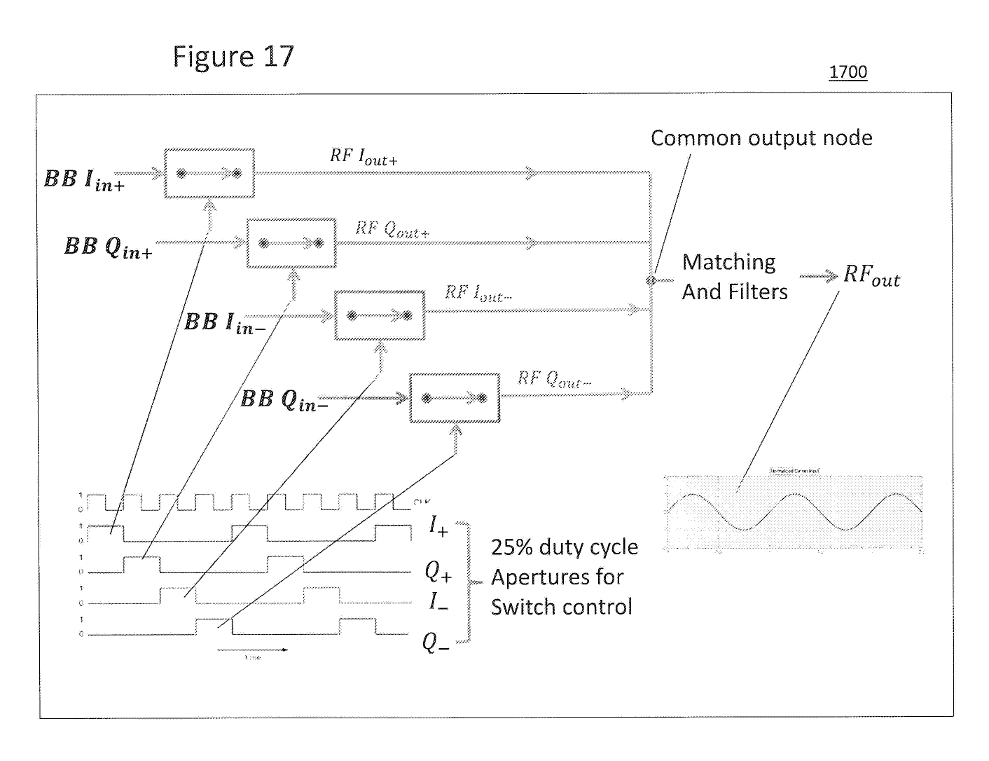

FIG. 17 illustrates an embodiment of a 25% duty cycle D2d™ complex up converter 1700. An RF input signal is generated by the circuitry controlled by a sample clock generator that has a 25% duty cycle and apertures for switch control. As shown, BBI_in (+ and −) and BBQ_in (+ and −) are provided as inputs to the upconverter to generate RF_out.

### Other Embodiments

The present invention includes many alternate embodiments such as a method and apparatus for controlling one or more antennae comprising unique and independent control of modulated or unmodulated phase and gain for two or more signals using energy sampling methods. These sampling methods can include using a D2p™ sampled up converter or a D2d™ sampled down converter.

Additionally, embodiments of the invention are directed to direct sampled phase control implemented with a complex sampled up converter. This can be accomplished using a D2p™ sampled up converter. This can also be accomplished D2d™ sample down converter.

Embodiments of the invention can be used in a phased array application, MIMO application, and/or diversity processing application.

Further, embodiments of the invention can be used in simplex communication systems, half duplex systems, full duplex systems, multiplexed systems, or any combination thereof.

Embodiments of the invention can be used for point to multipoint RF distribution application and/or point to point RF link applications.

Embodiments of the invention are directed methods and apparatuses for transmit phase control through vector decomposition and projection at the sampled up converter. This can be accomplished in conjunction with methods and apparatuses for controlling one or more antennae comprising unique and independent control of modulated or unmodulated phase and gain for two or more signals using energy sampling methods.

According to some embodiments, the sampling apertures of the Tx sample clock and/or the sampling apertures of the Rx sample clock can be adjusted for the purpose of gain weighting.

In some embodiments, methods and apparatuses for controlling one or more antennae comprising unique and independent control of modulated or unmodulated phase and gain for two or more signals using energy sampling methods can include direct scaling of I and/or Q Baseband signals for gain control of Tx path and/or direct scaling of I and/or Q Baseband signals for gain control of Rx path.

Embodiments of the invention can be combined with dynamic steering of an antenna beam main lobe, steering of antenna beam ancillary lobes, steering of relative antenna beam nulls, or steering of any combination thereof.

### CONCLUSION

It is to be appreciated that the Detailed Description section, and not the Summary and Abstract sections, is intended to be used to interpret the claims. The Summary and Abstract sections can set forth one or more but not all example embodiments of the present invention as contemplated by the inventors, and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the relevant art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by a person skilled in the relevant art in light of the teachings and guidance.

The breadth and scope of the present invention should not be limited by any of the above-described example embodiments, but should be defined only in accordance with the following claims and their equivalents.

What is claimed is:

1. An apparatus comprising:
an array of antenna elements; and
a controller configured to independently control modulated or unmodulated phase and modulated or unmodulated gain for two or more signals received or transmitted by the array of antenna elements using energy sampling techniques.
